(19) United States
(12) Patent Application Publication
(10) Pub. No.: US 2017/0346370 A1
(43) Pub. Date: Nov. 30, 2017

(54) MAINTAINABLE LIQUID COOLING JACKET FOR MOTORS

(71) Applicant: Board of Regents, The University of Texas System, Austin, TX (US)

(72) Inventors: Luis Sentis, Austin, TX (US); Nicholas Paine, Austin, TX (US)

(21) Appl. No.: 15/604,463

(22) Filed: May 24, 2017

Related U.S. Application Data
(60) Provisional application No. 62/340,903, filed on May 24, 2016.

(51) Int. Cl. H02K 9/193; H02K 7/116; H02K 15/00; H02K 15/14

(52) U.S. Cl. CPC H02K 9/193; H02K 15/14; H02K 7/116; H02K 15/0006

(57) ABSTRACT

A liquid-cooled motor may include a removable liquid cooling jacket. The jacket may enclose a commercial off-the-shelf electric motor. The jacket may be ribbed and may include multiple fluid channels, allowing fluid to circulate over the surface of the electric motor and limiting eddy currents. A front-most portion of the liquid-cooled motor may include electrical and fluid interfaces, including an inlet and an outlet for tubing to carry fluids. Removable gaskets or O-rings may be placed between the front-most portion and the jacket, and between a rear-most portion and the jacket. The jacket may be connected to the front-most portion and the rear-most portion using removable screws. The liquid-cooled motor may be disassembled for maintenance and then re-assembled. The jacket, front-most portion, and rear-most portion may be 3D printed from a watertight acrylic polymer, or machined from an engineering thermoplastic.

### CROSS-REFERENCE TO RELATED APPLICATIONS

This application claims priority from U.S. Provisional Application No. 62/340,903, filed May 24, 2016, entitled “MAINTAINABLE LIQUID COOLING JACKET FOR MOTORS,” the contents of which is incorporated herein by reference.

### STATEMENT OF GOVERNMENT INTEREST

This invention was made with government support under Grant no. NNX12AQ99G awarded by the National Aeronautics and Space Administration. The government has certain rights in the invention.

### FIELD OF THE DISCLOSURE

The present disclosure relates generally to the field of robotic actuators and, more particularly, to robotic actuators that include maintainable liquid cooling jackets around their motors.

### DESCRIPTION OF THE RELATED ART

Actuation for robotic applications is best provided by an actuator that is light-weight, and compact, with an ability to generate high power and force, yet efficient in its operation. Such applications typically require that the actuator is capable of precise force control and is shock-tolerant. Actuators that are overly heavy or bulky strain the other elements of the system in which they function, and limit the performance of the system and the scope of possible applications. Conventional applications in the robotics and transportation industries have gravitated towards electric motors due to their high operating efficiency (often above 90%) and their ubiquitous, low-cost and miniaturized embedded motion controllers. While these benefits often outweigh the shortcomings of electric motors compared to other actuation technologies, new applications in robotics and related fields require improvement over the current state-of-the-art. Some existing actuator designs are focused on a subset of the following attributes to the detriment of others: efficiency, power density, impact tolerance, position controllability, and force controllability. For example, hydraulic actuators exhibit above average power density, impact tolerance, position controllability and force controllability, but poor efficiency. Pneumatic actuators exhibit relatively good impact tolerance, but below average performance in other areas. Geared electric (air-cooled) actuators exhibit good efficiency and position controllability, but poor power density, impact tolerance, and force controllability.

Liquid-cooled electric motors are typically reserved for large, expensive, high-end applications where the design of the motor's electromagnetic components are closely coupled to its cooling system. Because these motors are typically custom made, they can be very expensive and require a long development time. Commercial off-the-shelf (COTS) motors are cheap and easy to control. However, this type of motor is rarely designed for use with liquid cooling

Precise force control requires actuators to contain some form of force feedback, which takes up space and adds mass. Traditional actuation approaches, commonly used in rigid factory room automation robots, do not include such force feedback. A more recent approach, Series Elastic Actuation (SEA), employs an elastic element in series with the mechanical energy source to detect the actuator force applied to the load, and incorporates this force measurement into a feedback control scheme. Electrically powered SEAs typically contain an electric motor to generate mechanical power, a speed reduction element to amplify motor torque, a spring to sense force, and a transmission mechanism to route mechanical power to the output joint.

### SUMMARY

The disclosure relates to systems and methods for providing liquid cooling for commercial off-the-shelf motors. In one aspect, a disclosed liquid-cooled motor may include a front-most portion, including a cavity through which an output shaft of the liquid-cooled motor extends, and a fluid interface including an inlet and an outlet through which liquid is to flow. The disclosed liquid-cooled motor may also include a motor housing portion, including an electric motor and a liquid cooling jacket in which the electric motor is enclosed, the liquid cooling jacket comprising a plurality of fluid channels that encircle the electric motor, and one or more removable fluid seals between the front-most portion and the motor housing portion.

In any of the disclosed embodiments, the one or more removable fluid seals may include one or more rubber gaskets or O-rings.

In any of the disclosed embodiments, the front-most portion and the motor housing portion may be connected to each other using one or more removable screws.

In any of the disclosed embodiments, the motor jacket may be constructed using a three-dimensional (3D) printing process.

In any of the disclosed embodiments, the front-most portion may be machined from a polymer, a resin, a plastic, or an engineering thermoplastic.

In any of the disclosed embodiments, the electric motor may be a commercial off-the-shelf electric motor.

In any of the disclosed embodiments, the liquid-cooled motor may further include a rear-most portion and one or more removable fluid seals between the rear-most portion and the motor housing portion. The rear-most portion and the motor housing portion may be connected to each other using one or more removable screws.

In any of the disclosed embodiments, the rear-most portion may be machined from a polymer, a resin, a plastic, or an engineering thermoplastic.

Another a disclosed aspect includes a method for fabricating a liquid-cooled motor. The method may include obtaining an electric motor, producing a liquid-cooling jacket of suitable size and shape to enclose the electric motor, the liquid-cooling jacket including multiple fluid channels, and producing a front-most portion of the liquid-cooled motor. The front-most portion may include a fluid interface comprising an inlet fitting for tubing and an outlet fitting for tubing and a cavity through which an output shaft of the electric motor extends when the liquid-cooled motor is assembled. The method may also include assembling the liquid-cooled motor, including enclosing the electric motor in the liquid-cooling jacket, placing one or more removable fluid seals between the liquid-cooling jacket and the front-most portion, and attaching the front-most portion to the liquid-cooling jacket using one or more removable screws.

In any of the disclosed embodiments, producing the liquid-cooling jacket may include creating the liquid-cooling jacket using a three-dimensional (3D) printing process.

In any of the disclosed embodiments, producing the liquid-cooling jacket may include creating the liquid-cooling jacket from a watertight acrylic polymer.

In any of the disclosed embodiments, obtaining an electric motor may include obtaining a commercial off-the-shelf electric motor.

In any of the disclosed embodiments, the one or more removable fluid seals may include one or more gaskets or O-rings.

In any of the disclosed embodiments, the method may further include producing a rear-most portion, and assembling the liquid-cooled motor may further include placing one or more removable fluid seals between the liquid-cooling jacket and the rear-most portion, and attaching the rear-most portion to the liquid-cooling jacket using one or more removable screws.

In any of the disclosed embodiments, producing a front-most portion of the liquid-cooled motor may include machining the front-most portion from a polymer, a resin, a plastic, or an engineering thermoplastic. In any of the disclosed embodiments, producing a rear-most portion of the liquid-cooled motor may include machining the rear-most portion from a polymer, a resin, a plastic, or an engineering thermoplastic.

In any of the disclosed embodiments, the method may further include, subsequent to the assembling, detaching the rear-most portion from the liquid-cooling jacket by removing at least one removable screw, replacing at least one of the one or more removable fluid seals between the liquid-cooling jacket and the rear-most portion, and re-attaching the rear-most portion to the liquid-cooling jacket using at least one removable screw.

In any of the disclosed embodiments, the method may further include, subsequent to the assembling, detaching the front-most portion from the liquid-cooling jacket by removing at least one removable screw, replacing at least one of the one or more removable fluid seals between the liquid-cooling jacket and the front-most portion, and re-attaching the front-most portion to the liquid-cooling jacket using at least one removable screw.

In another aspect, a disclosed robotic actuator may include a liquid-cooled motor to generate mechanical power, a speed reduction element to amplify motor torque, an elastic element to sense force, and a transmission mechanism to route mechanical power to an output joint. The liquid-cooled motor may include a removable liquid-cooling jacket in which an electric motor is enclosed.

In any of the disclosed embodiments, the liquid-cooled motor may include a front-most portion, including a cavity through which an output shaft of the liquid-cooled motor extends and a fluid interface including an inlet and an outlet through which liquid is to flow. The liquid-cooled motor may also include a motor housing portion, including the electric motor and the removable liquid cooling jacket, and one or more removable fluid seals between the front-most portion and the motor housing portion. The removable liquid cooling jacket may include a plurality of fluid channels that encircle the electric motor. The front-most portion and the motor housing portion may be connected to each other using one or more removable screws

### BRIEF DESCRIPTION OF THE DRAWINGS

Embodiments of the present disclosure may be better understood through reference to the following figures in which:

FIGS. 1A and 1B illustrate circuit models of an electric motor, according to at least some embodiments;

FIGS. 2A-2C illustrate different views of an example liquid-cooled motor, according to one embodiment;

FIGS. 3A and 3B illustrate different views of an example of a liquid-cooled motor driver, according to one embodiment;

FIG. 4 illustrates an example motor test bed, according to one embodiment;

FIG. 5 is a block diagram illustrating an example hardware interface for motor testing, according to one embodiment;

FIG. 6 is a block diagram illustrating the locations of power measurements in an example motor test bed, according to one embodiment;

FIGS. 7A and 7B illustrate two different arrangements of the components of a series elastic actuator, according to at least some embodiments;

FIGS. 8A-8D illustrate models for series elastic actuators, according to at least some embodiments;

FIG. 9 illustrates a circuit model of a locked-output series elastic actuator, according to at least some embodiments;

FIG. 10 illustrates an example torque controller, according to at least some embodiments;

FIG. 11A illustrates an example viscoelastic actuator, according to one embodiment;

FIG. 11B illustrates an example circuit model for the viscoelastic actuator shown in FIG. 11A, according to one embodiment;

FIGS. 12A and 12B illustrate different views of an example series elastic actuator, according to one embodiment;

FIGS. 13A-13C illustrate the deformation of an elastic element of an example series elastic actuator under different loading conditions, according to one embodiment;

FIG. 14 illustrates the use of a series elastic actuator to drive a rotary joint, according to one embodiment;

FIG. 15 illustrates an example viscoelastic liquid-cooled actuator (VLCA), according to one embodiment;

FIG. 16 illustrates the liquid-cooled motor of the example VLCA shown in FIG. 15, according to one embodiment;

FIG. 17 illustrates the use of a VLCA in a robotic leg, according to one embodiment;

FIG. 18 illustrates an example two-degree-of-freedom VLCA test bed, according to one embodiment;

FIG. 19 illustrates selected elements of an example method for providing liquid cooling for a commercial off-the-shelf motor, according to at least one embodiment; and

FIG. 20 illustrates selected elements of an example method for designing and building a viscoelastic liquid-cooled actuator (VLCA), according to at least one embodiment.

### DETAILED DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments. For a more complete understanding of the present disclosure, reference is made to the following description and accompanying drawings.

Actuators are the building blocks of robots, and at least some of them are generic enough to be used in other types of applications. While systems and methods for designing and building high-performance robotic actuators are described herein primarily in terms of their use in legged robot applications, in other embodiments of the present disclosure, these systems and methods may be applied to actuators used in other contexts. In at least some embodiments, these systems and methods may be applied in robotic applications such as the helpful humanoid house assistant or the disaster robotic first-responder. These types of applications may impose simultaneous contradicting requirements on robotic actuators, including a large torque/mass ratio, a large power/mass ratio, and efficiency. In these applications, it may be desirable to provide the smallest device that can lift the largest (or heaviest) load. In this quest for the highest power density, the ultimate limitation on the actuators may be based on thermal limitations. In at least some embodiments of the present disclosure, the robotic actuators described herein may operate with increased thermal capabilities when compared to existing devices.

Two features of the robotics actuators described herein may be implemented individually and/or collectively to contribute to improvements in the power density and position controllability of robotic actuators, in various embodiments. For example, by providing a maintainable liquid cooling jacket for commercial off-the-shelf motors used in robotic actuators, the continuous torque output of these motors may be increased two-fold or more over their datasheet specifications. In addition, by incorporating series elastic actuators that use a viscoelastic material in compression, the position controllability of the robotic actuators may be improved when compared to existing series elastic actuators.

Liquid cooling of electric motors is a technology that is commonly used today in a wide range of electric vehicles. Compared to the transportation industry, however, less work has been done to explore the application of single-phase liquid cooling to robotic applications. The existing work in robotics can be largely grouped into two distinct categories, each of which benefits from an increase in continuous torque production. The first category involves the application of liquid cooling to direct drive robotic joints. The second category involves the combined effects of liquid cooling and a highly geared drivetrain to sustain large continuous joint torques with minimal system mass. Unlike the large and expensive motors used in the transportation industry or the complex and custom-made direct drive motors, motors intended for geared applications are commercially-available off-the-shelf (COTS) motors, making them ubiquitous and relatively inexpensive. However, this type of motor is rarely designed for use with liquid cooling. In at least some embodiments of the present disclosure, the motors described herein may be less expensive, yet more torque-dense and power-dense than the motors currently available for use in robotics. A few examples of robotic applications that may benefit from the use of these electric motors include life-sized autonomous humanoid robots, rehabilitation exoskeletons, and electric vehicles.

As described in more detail below, in some embodiments of the present disclosure, a maintainable liquid cooling jacket may be designed and built for use with a commercial off-the-shelf (COTS) electric motor. The liquid cooling jacket may include multiple parts that can be assembled and subsequently disassembled, such as for maintenance purposes. In some embodiments, the portion of the liquid cooling jacket that encloses the motor may be built relatively inexpensively, e.g., using a 3D printer. By cooling the motor using the liquid cooling jacket, more strength and energy may be obtained from the motor.

### Thermal Modeling of Electric Motors

Performance improvements that are achievable when using liquid cooling may be predicted by modeling thermal behavior. As energy transducers, electric motors convert electric energy into mechanical energy. However, loss is incurred in the process and manifests itself as heat generated by the motor. Two main sources of loss contribute to this heating: mechanical friction and Ohmic loss (also referred to as Joule heating or resistive loss). Ohmic loss (Pₑ) depends on instantaneous motor current (I) and on the winding resistance (Rₑ):

Pₑ=I²Rₑ. (1)

At a small motor load, mechanical friction is the largest source of loss, while Ohmic loss dominates at larger loads. In the discussions herein, the relatively small losses due to mechanical friction are disregarded.

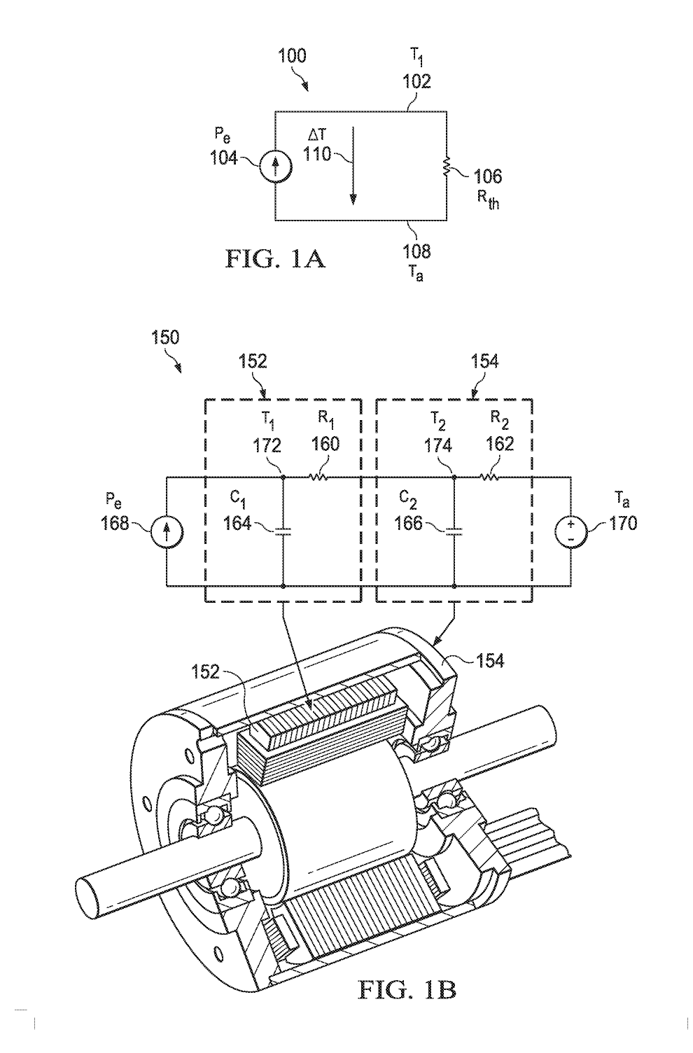

FIGS. 1A and 1B illustrate circuit models of an electric motor, according to at least some embodiments. For example, circuit model 100, shown in FIG. 1A, describes the steady-state thermal behavior of an electric motor subject to Ohmic losses. In this model, heat current, Pₑ (104) is injected into the system and is dissipated to the surrounding environment through a lumped thermal resistance, Rₜₕ (106) representing the combined effects of conduction, convection and radiation. A temperature difference, ΔT (110) is produced between the motor's core temperature, T₁ (102) and the ambient air temperature, Tₐ (108). At steady state, the motor core temperature can be calculated using Ohm's law, as follows:

$${P}_{e} = \frac{Δ T}{{R}_{th}} = \frac{{T}_{1} - {T}_{a}}{{R}_{th}} . \qquad ( 2 )$$

In this example, given the thermal resistance Rₜₕ (106), Ohmic losses Pₑ (104) and ambient temperature Tₐ (108), the motor's core temperature T₁ (102) can be calculated. Given the maximum permissible motor winding temperature (T₁_{ₘₐₓ}) for the motor, Equations (1) and (2) may be combined to calculate the maximum thermally-permissible continuous current, as follows:

$${I}_{c} = \sqrt{\frac{{T}_{{1}_{ma x}} - {T}_{a}}{{R}_{th} {R}_{e}}} \qquad ( 3 )$$

Note that Rₜₕ (106) represents a thermal resistance, while Rₑ represents an electrical resistance. In this example, Equation (3) depends on Rₑ, which is itself a function of temperature. This relationship may be defined by the resistor temperature coefficient equation, as follows:

Rₑ(T)=Rₒ[1+α(T−Tₒ)] (4)

Here, Rₒ represents the nominal resistance at the nominal temperature (Tₒ) and α represents the winding material's temperature coefficient. For example, copper has an α of around 0.0039Ω/° K. From Equation (3), it is apparent that Rₜₕ plays a critical role in determining maximum continuous current. The other parameters, (T₁_{ₘₐₓ}), Tₐ and Rₑ, cannot be significantly altered from nominal values. Alternatively, Rₜₕ is very sensitive to design and environmental factors.

A more accurate thermal model is illustrated in FIG. 1B, along with a corresponding example motor. This model contains additional elements, including R₁ (160) to represent the thermal resistance between the motor core (e.g., winding 152) and the motor housing 154, C₁ (164) to represent the thermal capacitance of the motor's core (winding 152), R₂ (162) to represent the thermal resistance between the motor housing 154 and the environment, and C₂ (166) to represent the thermal capacitance of the motor's housing 154. As in FIG. 1A, the model includes Tₐ (170) to represent ambient temperature and Pₑ (168) to represent Ohmic losses. Several motor manufacturers provide these parameters in motor datasheets. The model illustrated in FIG. 1B improves over FIG. 1A in that it more accurately captures the transient response of the motor to a thermal load and also breaks down the lumped thermal resistance into two distinct components. Given winding-to-housing thermal resistance R₁ (160) and capacitance C₁ (164) and housing-to-ambient thermal resistance R₂ (162) and capacitance C₂ (166), the motor's thermal transient response can also be modeled. From Equation (3), it is apparent that Rₜₕ should be minimized in order to maximize a motor's torque-to-mass ratio. This may be a consideration for any high-performance motor design and is often addressed either by using forced convective air cooling or by adopting liquid cooling. A comparison of typical values for mean convective heat transfer coefficients for free convention in air, forced convection in air, free convention in water, and forced convection in water demonstrates the benefits of liquid cooling with water, where water exhibits up to a 50× improvement in convective heat transfer compared to air. The range of mean convective heat transfer coefficients for each of these situations may be dependent on a number of factors affecting convective heat transfer, such as the rate of fluid flow and the surface shape.

### Thermal Ratio

In the case of liquid cooling, custom motor designs typically pass cooling fluid as close to the heat-generating windings as possible in order to reduce Rₜₕ. However, it may not always be possible to create custom motor designs, due to the cost, time and/or complexity of the target system. In some embodiments of the present disclosure, an alternative approach may be to apply liquid cooling to COTS motors to improve their performance. In such embodiments, the fundamental design of the motor is not altered. This implies that R₁ must stay fixed while R₂ may be reduced using liquid cooling. Taking this constraint into consideration, the thermal ratio (ρ) of a motor (which may represent a theoretical improvement factor) may be defined as the maximum achievable improvement of continuous current (Equation (3)) assuming R₁ must remain fixed and R₂ can be made close to zero using liquid cooling rather than air cooling. The thermal ratio may be derived by taking the ratio of two continuous currents, one with Rₜₕ=R₁, (I_{c1}) and the second with Rₜₕ=R₁+R₂, (I_{ca}), as follows:

$$ρ = \frac{{I}_{{c}_{1}}}{{I}_{{c}_{a}}} = \sqrt{\frac{{R}_{1} + {R}_{2}}{{R}_{1}}} . \qquad ( 5 )$$

Note that the type of motor and its design may significantly affect the potential benefit of adding liquid cooling. For example, one motor may be able to tolerate over 8 times the continuous current of air cooling when liquid cooling is applied (assuming the added heat can be adequately dissipated), while another motor's continuous current may only be increased by a factor of 1.56×.

### Core Temperature Estimation

While liquid cooling may significantly improve continuous current output of electric motors, it does not have the same effect on short-term current output. To gain insight into the maximum permissible short-term current output, the thermal control concept was introduced. This concept involves a method to estimate the core motor temperature based on current and previous state measurements. This method may be more effective than placing a temperature sensor directly on the motor's windings due to the temperature difference between the winding core and its surface and the winding's associated thermodynamics. Two differential equations may fully describe the thermal circuit model shown in FIG. 1B, as follows:

$$\begin{matrix}\frac{{dT}_{1}}{dt} = \frac{1}{{C}_{1}} [ {P}_{e} - \frac{{T}_{1} - {T}_{2}}{{R}_{1}} ] & ( 6 a ) \\ \frac{{dT}_{2}}{dt} = \frac{1}{{C}_{2}} [ \frac{{T}_{1} - {T}_{2}}{{R}_{1}} - \frac{{T}_{2} - {T}_{a}}{{R}_{2}} ] & ( 6 b )\end{matrix}$$

Given accurate initial conditions and measurements of Tₐ (170), which represents ambient temperature, and Pₑ (168), which represents Ohmic losses (e.g., by measuring motor current), these equations may be integrated in real time using, for example, Euler integration, to estimate the values of T₁ (172) and T₂ (174). If T₂ (174) is directly measured, such as in the experimental test bed described herein, then T₁ (172) may be calculated from Equation (6a) alone.

By allowing liquid cooling to be applied to pre-existing motor designs, the techniques described herein may help bring the performance advantages of liquid cooling to smaller scale and lower cost applications. To improve the understanding of the benefits of applying maintainable liquid cooling jackets to COTS electric motors, empirically-observed factors of improvement for motor current, torque, output power and system efficiency are described herein. Specifically, empirically-measured factors of improvement are provided not only for continuous current, but also for continuous power output. These results were gathered on a specially-designed and heavily-instrumented test bed that also measures actuation efficiency versus load. An abundance of temperature sensors enabled direct measurement and comparison of the motor's thermal resistance in air-cooled and liquid-cooled scenarios. These measurements were obtained using a liquid-cooled motor housing design that improves the ease of maintenance and component reuse compared to existing liquid cooling solutions. More specifically, an effective design for a retrofitted liquid-cooled motor housing was built and demonstrated. The design improves upon existing work at least in that it is non-permanent and removable, which facilitates periodic maintenance and component reuse, beneficial features for a well-designed machine.

It is confirmed that datasheet motor thermal properties may serve as a reasonable guide for anticipating continuous torque performance, but may over-specify continuous power output. For the motor used in many of the tests described herein, continuous torque output was increased by a factor of 2.58 by applying liquid cooling, matching to within 9% of expected datasheet values. In addition, continuous power output was increased by a factor of two with only 2.2% reduced efficiency compared to air-cooling.

In various embodiments, the approach described herein for designing and building a maintainable liquid cooling jacket may be applied to different types of commercial off-the-shelf motors. In some cases, a different casing may be created (e.g., with a 3D printer) for each different motor (or motor type) to which liquid cooling is to be applied. In other cases, a single casing design may be used in the liquid cooling jackets for two or more different motors (or motor types). In some embodiments, one or more other components of the liquid cooling jackets (e.g., a front-most portion or a rear portion, either or both of which may be machined parts) may be used with two or more different casing designs. In at least some embodiments of the present disclosure, adding a maintainable liquid cooling jacket to a commercial off-the-shelf motor may significantly improve its performance, without having to change the motor itself and without having to design the motor to support the addition of the maintainable liquid cooling jacket.

### Example Liquid-Cooled Motor System

The design of a retrofitted liquid-cooled motor and the auxiliary systems required for accurately measuring and characterizing its performance are described in more detail below, according to at least some embodiments. In addition to the typical motor performance requirements, such as large torque/mass and large power/mass, a COTS motor to be used with liquid cooling may satisfy several additional requirements, such as high magnetic saturation and/or low thermal resistance. For example, because of the large currents experienced with liquid cooling, these large currents must not saturate any flux-producing elements of the motor. Motors with iron cores may be more susceptible to this effect than are coreless motor designs. In another example, the proximity of the heat-generating winding to the outside surface of a motor may vary significantly by motor type and motor design. In the case that R₁ and R₂ values are not provided by the motor manufacturer, motor designs featuring stationary windings with a short thermal path to the liquid-cooled surface may be more suitable for the application of the maintainable liquid cooling jackets described herein. Motor types matching these characteristics may include internal rotor brushless DC/AC motors and/or stepper motors. Conversely, motors that are less suitable for the application of the maintainable liquid cooling jackets described herein may include external rotor brushless DC/AC, brushed DC, universal and/or induction motors.

In one example, a motor was chosen to demonstrate the application of the maintainable liquid cooling jackets described herein using (along with a desired power range of 100 W to 200 W) the following two metrics:

$$\begin{matrix}\frac{Continuous Power \cdot Thermal Ratio}{Mass \cdot Cost} & ( 7 a ) \\ \frac{Continuous Torque \cdot Thermal Ratio}{Mass \cdot Cost} & ( 7 b )\end{matrix}$$

The motor chosen (a 100-W motor) was selected based on its datasheet thermal parameters, shown in Table 1 below:

TABLE 1
100-W motor datasheet thermal parameters

| Parameter | Value | Units |
|---|---|---|
| R₁ | 1 | K/W |
| R₂ | 7 | K/W |
| Rₑ | 0.797 | Ω |
| T₁ₘₐₓ | 155 | C. |

From Equation (5), the thermal ratio for this motor was calculated to be 2.83, yielding a theoretical air-cooled continuous current of 3.71 A (which was calculated using Equation (3), assuming an ambient temperature of 25° C.). In this case, Ohmic losses would be 16.2 W. Using liquid cooling, the continuous current is increased to 10.5 A, generating Ohmic losses of 130 W. In at least some embodiments of the present disclosure, this large amount of heat is efficiently carried away from the motor case, as described below.

### Example Retrofitted Liquid-Cooled Motor Housing

To demonstrate the application of a maintainable liquid cooling jacket, a fluid conducting housing was designed to fit the chosen 100-W motor described above with three main goals: (1) to provide a water-tight seal around the motor for the 1.5-bar fluid pressure generated by the liquid cooling pump; (2) to ensure the fluid is circulated over the entire surface of the motor, limiting eddy currents where possible; and (3) to produce a design that can be disassembled for cleaning and maintenance if needed. To satisfy these requirements, a liquid-cooled motor housing design was developed that is composed of three sections.

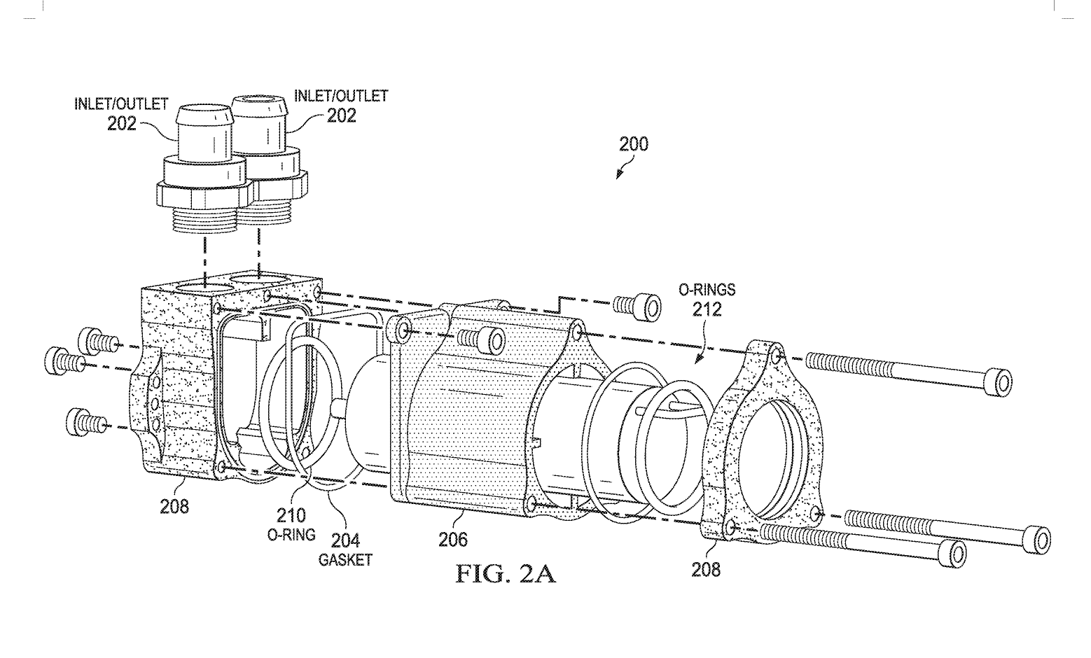

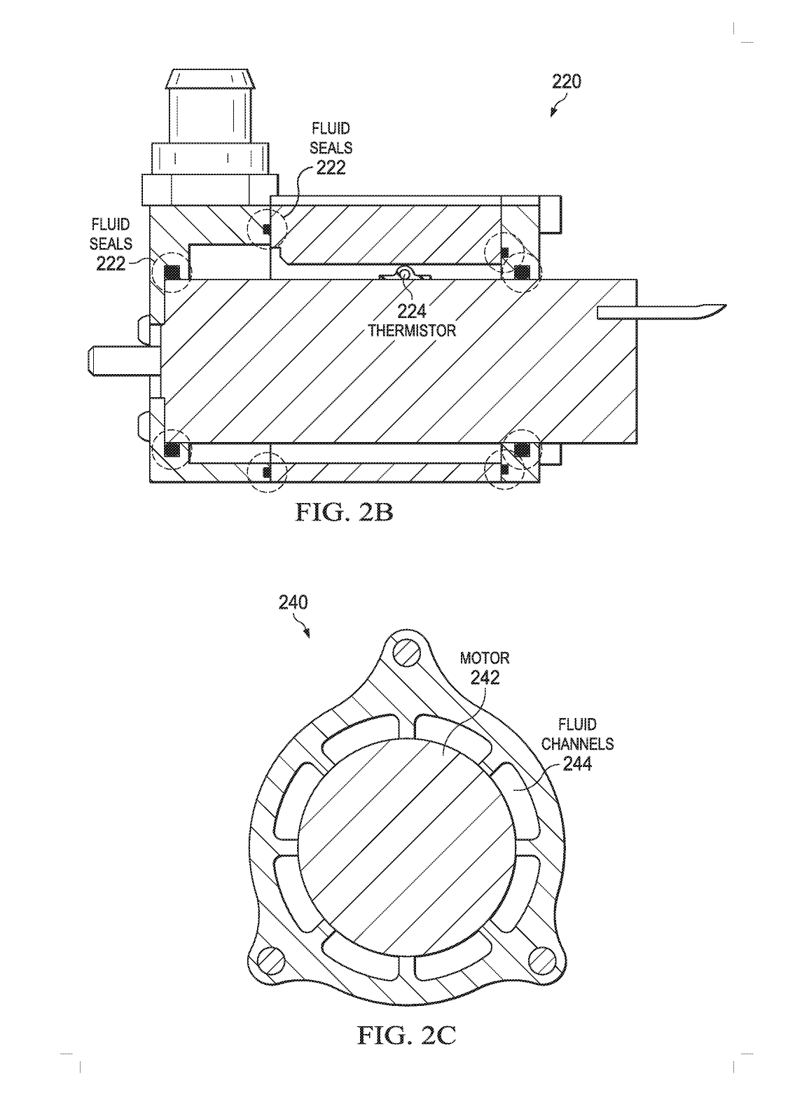

FIGS. 2A-2C illustrate different views of an example liquid-cooled motor that includes a casing to house and circulate cooling fluid around the motor, according to one embodiment. More specifically, FIG. 2A illustrates an exploded view 200 of the liquid-cooled motor, FIG. 2B illustrates a side cross-section 220 of the liquid-cooled motor, and FIG. 2C illustrates a front cross-section 240 of the liquid-cooled motor. In this example, the front-most sections, where the motor's output shaft is located, serve as both the mechanical and fluid interface for the motor, including inlet/outlet fittings 202. In this example, because it requires mechanical strength, corrosion resistance, chemical inertness and high machining tolerances, the body of this section may be machined (e.g., using a computer controlled machining process) from an engineering thermoplastic such as Dupont™ Delrin® (which is also known as polyoxymethylene, shown as 208) or another high stiffness, low friction, and dimensionally stable material. In the illustrated embodiment, the liquid-cooled motor also includes two fluid seals 222 (shown in FIG. 2B), including a COTS silicone O-ring (210) with a 70-A durometer hardness and a custom-designed gasket (204) laser-cut from rubber (such as ethylene-propylene-diene monomer, or EPDM) with a 60-A durometer hardness. In this example embodiment, these fluid seals are designed for a 30% squeeze (O-ring compression) to provide a watertight barrier. In other embodiments, the fluid seals in a liquid-cooled motor may be made of other materials having different specifications.

In this example embodiment, the middle section of the liquid-cooled motor housing circulates the fluid around the full surface of the motor 242, following a ribbed design that includes multiple fluid channels 244 that encircle the motor 242. In this example, because it requires lower tolerances (e.g., ±0.127 mm), cost may be saved by 3D printing the body 206 of this part from watertight acrylic polymer using a UV curing process. An additional set of O-rings 212 provides a seal to the third, rear-most part of the housing, which is retained to the rest of the assembly with screws. Unlike other liquid-cooled motors that use sealing adhesive to join housing components together, this O-ring-based design may better facilitate disassembly, allowing for component reuse and periodic maintenance, if required. In this example embodiment, the body of the rear-most section may also be machined (e.g., using a computer controlled machining process) from an engineering thermoplastic such as Dupont™ Delrin® (which is also known as polyoxymethylene, shown as 208) or another high stiffness, low friction, and dimensionally stable material.

In this example embodiment, the motor case temperature is measured using a pre-calibrated thermistor 224. The thermistor is secured to the motor case with thermally-conductive epoxy (which serves as a potting compound) with a thermal conductivity of 0.682 W/mK, which is similar to that of water. In this example embodiment, one hole is drilled into the middle part of the liquid cooling housing assembly through which the thermistor's leads are routed. A non-permanent room-temperature vulcanized silicone rubber seal may be used at this interface (not shown).

### Retrofitted Liquid-Cooled Servo Drive Water Block

In this demonstration of the application of a maintainable liquid cooling jacket, because motor current must also pass through the motor servo drive, a water block was designed to cool this component, as well. In this example embodiment, the design requirements were similar to those of the motor's liquid cooling housing.

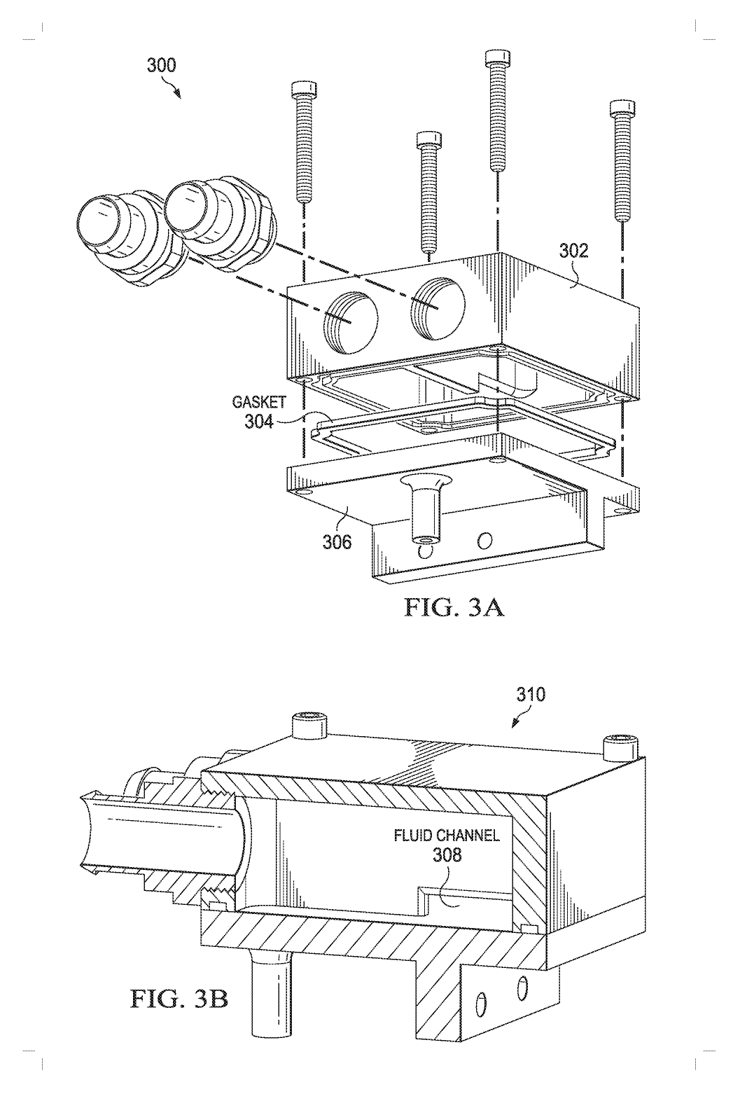

FIGS. 3A and 3B illustrate different views of an example of a liquid-cooled motor driver that includes a casing to house and circulate cooling fluid around the motor driver, according to one embodiment. More specifically, FIG. 3A illustrates an exploded view 300 of the motor driver and FIG. 3B illustrates a cross-section 310 of the motor driver. In this example embodiment, the body of the assembly 302 is machined (e.g., using a computer controlled machining process) from an engineering thermoplastic such as Dupont™ Delrin® (which is also known as polyoxymethylene) or another high stiffness, low friction, and dimensionally stable material. A custom-designed gasket (304) laser-cut from rubber (such as ethylene-propylene-diene monomer, or EPDM) provides the watertight seal. In other embodiments, the fluid seal in a liquid-cooled motor driver may be made of other materials having different specifications. At 306, copper was chosen to carry heat away from the servo drive, in this example embodiment. In other embodiments, aluminum may be used due to its lower density. In this example embodiment, a single fluid channel 308 is machined into the housing of the water block to force liquid to pass over the portion of the heat sink where heat is most concentrated.

In this example embodiment, the remaining liquid cooling components, such as the radiator, reservoir, pump and fittings, were commercially obtained from a personal computer (PC) liquid cooling company. High-flex PVC (polyvinyl chloride) tubing was used to connect these components together. Optimal sizing of the liquid cooling components may vary between different embodiments that include different motor drivers, materials, and applications. In the example test bed described herein, the flow rate of the coolant through the combined fluid resistances of the motor housing, servo drive water block and radiator was measured to be 0.036 L/s.

### Example Instrumentation and Dynamometry

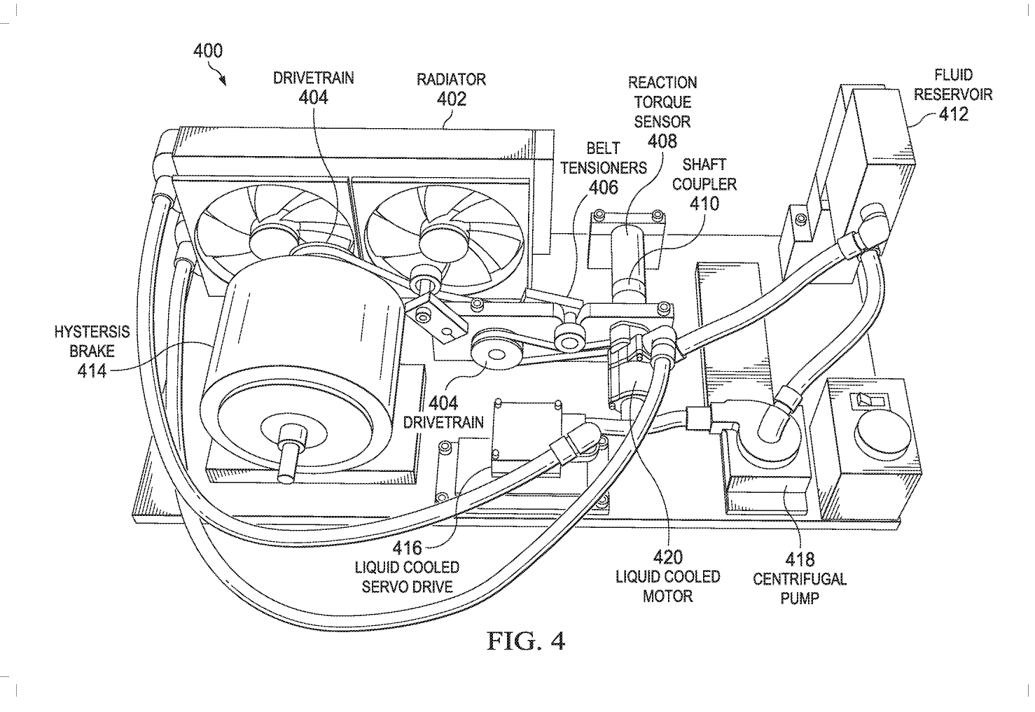

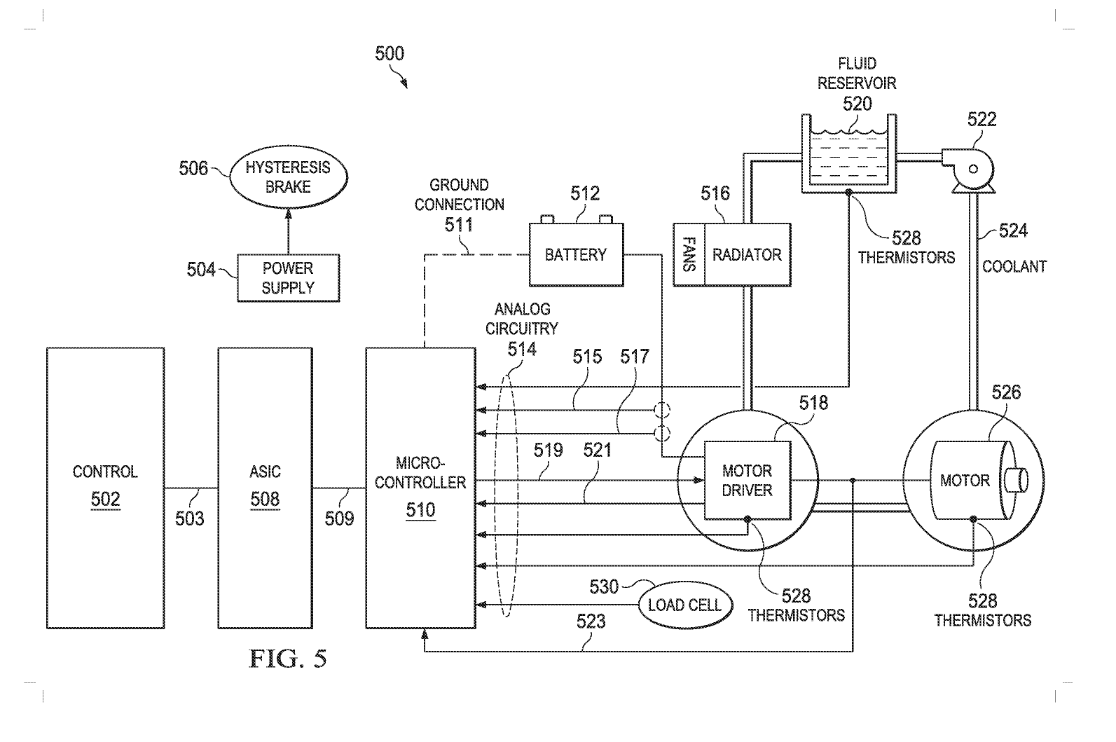

In some embodiments of the present disclosure, a controllable motor load and a large suite of sensors may be used to enable thermal control and to fully characterize motor performance. For example, FIGS. 4 and 5 illustrate components of a system for characterizing motor performance, according to at least some embodiments. More specifically, FIG. 4 illustrates an example motor test bed, according to one embodiment. This illustration shows the test bed as configured for liquid cooling. For the air cooling tests described herein, a bare motor was used. This system is interfaced to a microcontroller, as described below. In this example, test bed 400 includes a radiator 402, a pulley drivetrain 404, belt tensioners 406, a reaction torque sensor 408, a shaft coupler 410, a fluid reservoir 412, a hysteresis brake 414, a liquid-cooled servo drive 416 (which may be the same as or similar to the liquid-cooled motor driver illustrated in FIGS. 3A and 3B), a centrifugal pump 418, and a liquid-cooled motor 420 (which may be the same as or similar to the liquid-cooled motor illustrated in FIGS. 2A-2C).

In this example, the hysteresis brake 414 is capable of dissipating 300-W continuous and 1340-W peak power and is used as a variable motor load. With a thermal ratio of 2.83, the liquid-cooled motor (a 100-W motor) is expected to produce 283 W of power continuously. The brake's maximum speed is 6000 rpm, while the motor's maximum speed, driven by a 64-V battery supply, is 43,000 rpm. Therefore, a 7.68:1 two-stage pulley speed reduction (shown as 404) is used between the motor 420 and the hysteresis brake 414 to match their respective maximum speeds.

FIG. 5 is a block diagram illustrating an example hardware interface for motor testing, according to one embodiment. This example hardware interface was used for the experimental testing described herein. In this example embodiment, data are gathered on a microcontroller and then passed to a control PC via a peripheral slave mode interface (e.g., a slave mode interface in accordance with the Ethernet for Control Automation Technology, or EtherCAT®, protocol). In this example embodiment, the experimental setup of the motor test bed 500 includes a control computer 502, a power supply 504, a hysteresis brake 506, a peripheral slave mode interface shown as ASIC 508 (e.g., an EtherCAT module), and a microcontroller 510 (including inputs/outputs from analog circuitry 514, a ground connection 511 to/from battery 512, and inputs 523 from one or more Hall effect sensors). EtherCAT® is a registered trademark and patented technology licensed by Beckhoff Automation GmbH, Germany. In some embodiments, interconnect 503 between control computer 502 and ASIC 508 may be an interface in accordance with the EtherCAT protocol. In some embodiments, interconnect 509 between ASIC 508 and microcontroller 510 may be a Serial Peripheral Interface (SPI) bus. In this example embodiment, the experimental setup of the motor test bed 500 also includes analog circuitry 514 (including inputs/outputs 515 for current sense, 517 for voltage sense, 519 for current commands, and 521 for a current monitor), a motor driver 518 (which may be the same as or similar to the liquid-cooled motor driver illustrated in FIGS. 3A and 3B), thermistors 528, a brushless DC motor 526 (which may be the same as or similar to the liquid-cooled motor illustrated in FIGS. 2A-2C), a radiator 516, a fluid reservoir 520, a pump 522 (for pumping coolant 524), and a load cell 530.

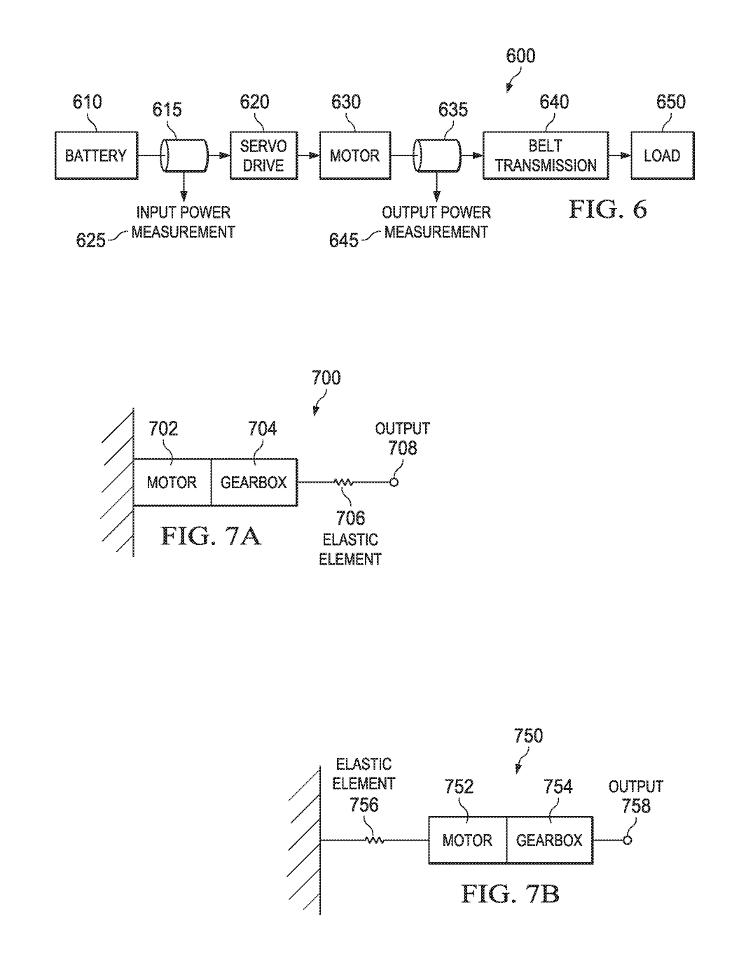

FIG. 6 is a block diagram 600 illustrating the locations of power measurements in an example motor test bed, according to one embodiment. In this example embodiment, motor test bed 600 includes a battery 610, a servo drive 620 (which may be the same as or similar to the liquid-cooled motor driver illustrated in FIGS. 3A and 3B), a motor 630 (which may be the same as or similar to the liquid-cooled motor illustrated in FIGS. 2A-2C), a belt transmission 640, and a load 650. In this example embodiment, input power measurements 625 are taken at 615, and output power measurements 645 are taken at 635.

More specifically, the following measurements are taken on the motor test bed: motor torque is measured using a reaction torque sensor, motor speed is measured based on the time between Hall effect sensor signal pulses, motor current is monitored using feedback from the motor servo drive, bus voltage is measured directly across the battery output terminals, bus current is measured from the negative battery terminal lead using a Hall effect sensor, motor case temperature is measured using a potted negative temperature coefficient (NTC) thermistor, servo drive temperature is measured using a potted NTC thermistor, and fluid reservoir temperature is measured using an NTC thermistor.

Coupled with the programmable hysteresis brake, this set of sensors enables thermal control and also direct measurement of input power, output power and, therefore, overall actuation system efficiency. In this example, efficiency is measured as the ratio of mechanical output power to electrical input power. Electrical power is measured from the power source (batteries) as voltage times current. Mechanical power is measured at the motor's output as angular velocity times torque. Measured efficiency therefore includes the motor and servo drive losses. However, for the efficiency measurement described herein, the additional power consumption of the liquid cooling pump was not considered. In the experimental test bed, the power consumed by the pump was relatively small compared to the maximum continuous power consumed by the motor (2.2%, 12 W versus 533 W). In a robotic system, this discrepancy would likely be larger, since a single pump can provide fluid flow to multiple motors. The efficiency measured by the test bed does include hysteresis, eddy current and Ohmic losses in the motor, as well as switching and Ohmic losses in the motor driver.

A primary goal of the exercise described below was to empirically determine and compare the maximum continuous power and torque production of air-cooled and liquid-cooled motors. To achieve this objective, the exercise was subdivided into four stages or experiments.

### Experimental Setup

To perform the experiments described below, the motor commands and all sensor data were interfaced through a microcontroller (shown as microcontroller 510 in FIG. 5). Data were transmitted to a control PC (shown as control computer 502 in FIG. 5). Due to the long duration of each test, sample rates between 100 Hz and 20 Hz were used. The hysteresis brake (shown as 506 in FIG. 5) was interfaced to a separate power supply (504), and its torque, which was measured with the test bed torque sensor, was set manually. Five 12-V lead acid batteries were used to supply between 60 V and 70 V to the motor driver. When performing tests that reach the maximum safe motor core temperatures, it may be important to be able to discern if and when damage to the motor occurs. Measurements of system operating efficiency were used for this purpose, and it was assumed that the system operating efficiency corresponds to the health of the motor. For example, between each high current experiment, a test was run to measure the system operating efficiency. In this way, it would be possible to determine if and when motor damage occurred.

In the first experiment, which was used to establish the maximum continuous motor current using air cooling and a fixed load, a stock motor without liquid cooling was used. The commanded motor current was first calibrated against an oscilloscope current probe attached to the motor phase wires. After calibration, a constant current was applied to the motor, and the hysteresis brake torque was set such that a low motor speed was achieved (between 2000 rpm and 3000 rpm). Through trial and error, the magnitude of the current was set such that the estimated core motor temperature would reach close to a steady-state value of 155° C., the maximum rated winding temperature.

The end result of this experiment was a continuous current value of 4.07 A (corresponding to 0.06 Nm of torque), which is 14% greater than the datasheet value for the motor of 3.57 A. This amplitude was empirically determined and caused the core motor temperature to reach an estimated steady-state value of 141.9° C. (a safety margin of 13.1° C. compared to the maximum rated value of 155° C.). This difference is due to the discrepancy between the datasheet and measured R₂ value, as described below. The core temperature was estimated using the thermal control technique described above. In addition, thermal model parameters R₁, τ₁=R₁C₁, R₂, τ₂=R₂C₂ were empirically identified, along with the experimental parameters. The identified thermal parameters matched the datasheet values for the motor except for R₂, which was 74% of the datasheet value (5.2 K/W vs. 7 K/W). This was determined to be an acceptable difference given the sensitivity of thermal resistance to environmental conditions, such as mounting conditions, air currents, etc. Simulated core temperature and case temperature values were extrapolated from the experimental data and used to determine the steady-state value of the core temperature. The continuous current and torque values determined in this experiment served as the baseline for comparisons with the liquid cooling experiments.

The second experiment was performed to measure the maximum output power and torque using continuous current, air cooling and a variable load. With the maximum continuous air-cooled current empirically determined (as described above), this current was then applied across the full operating range of the motor, from no load to a fixed load. This was achieved by first applying zero load torque with the hysteresis brake, causing the motor to spin up to no-load speed and then gradually increasing load torque to the point at which the motor stopped rotating.

The results of this experiment showed the maximum mechanical output power (213 W at 85.6% efficiency) achievable using the maximum air-cooled steady-state current of 4.07 A. The data collected included (a) the motor velocity response, in which the motor velocity first rose rapidly to the no-load speed, decreased with increasing load until it reached the constant torque region and then decreased linearly to zero; (b) the electrical input power and mechanical output power of the motor; and (c) the instantaneous motor operating efficiency. More specifically, power data were filtered with a zero-phase moving average filter with a window size of 1.5 s. From this plot, the maximum continuous power point was identified. The efficiency during peak power output was 85.6%. The efficiency itself peaked at around 92.5%, which is close to the datasheet value of 90%.

For the third experiment, which was used to establish the maximum continuous motor current using liquid cooling and a fixed load, liquid cooling was installed onto the motor and the servo drive. As an initial test, the motor current was set to follow a 7-A sine wave with no fluid circulation, causing the fluid around the motor to slowly heat up. Subsequently, after the motor case temperature had risen to 50° C., the pump for the liquid cooling system was turned on, causing the fluid to begin flowing past the radiator. In one second, the case temperature dropped by 24° C. back to ambient temperature (23.2° C.), demonstrating the importance of fluid flow in the convective heat transfer of liquid cooling.

To identify the maximum steady-state current, the commanded currents were increased until the maximum core temperature was reached with a safety margin of 24° C. The identified maximum continuous current was 9.65 A (0.15 Nm of torque), reaching a core temperature of 131° C. Note that the identified model for this case uses an R₂ value of 0.0325 K/W, meaning that the thermal resistance is smaller than that of ambient air cooling by a factor of 160 (5.2/0.0325). This is a significant improvement and is also sufficiently close to zero to verify the assumption of setting R₂ to zero to calculate the thermal ratio, as described above.

The experimental procedure for the fourth experiment, which was used to measure the maximum output power and torque using continuous current, liquid cooling, and a variable load mirrored that of the second experiment. The maximum liquid-cooled continuous current was set, and the load was then decreased from no load to a fixed load. Velocity, power, and efficiency were measured. The results of this experiment showed that the maximum continuous power reached a value of 430 W at 83.4% overall efficiency. Surprisingly, despite the dramatic increase in power by a factor of two, the overall decrease in efficiency between these two operating points was only 2.2% (85.6% versus 83.4%).

### Empirical Comparison of the Cooling Methods

By compiling the various trials of the first and third experiments, the performance of air cooling can be directly compared against that of liquid cooling. Here, the performance metric was steady-state continuous current, and the maximum current was defined to be the current that produces a steady-state core temperature of 155° C. A best fit curve was applied to both sets of data (the steady-state temperatures gathered during the separate trials) to allow direct comparison of the two cooling methods at the same steady-state core temperature. Based on this approach, liquid cooling the chosen 100-W motor resulted in an improvement in steady-state current by a factor of 2.58. In other words, by this metric, liquid cooling outperforms air cooling by a factor of 2.58 (4.07 A versus 10.5 A) for the chosen 100-W motor This empirical value matches to within 9% of the motor's datasheet thermal ratio value of 2.83 and is lower due to the experimental discrepancy of the R₂ parameter.

The retrofitted liquid cooling housing design described herein has been demonstrated to improve the performance of a commercial off-the-shelf motor. This design features high cooling performance (reaching a thermal resistance of R₂=0.035 K/W), and is based on a non-permanent O-ring-sealed structure. This provides advantages over existing permanently-sealed designs in that the cooling structure can be disassembled and cleaned periodically, and/or its O-rings and gaskets may be replaced, if necessary, without damaging the housing or the motor. Therefore, the liquid-cooled motor may last longer (in operation) than the existing permanently-sealed designs.

By directly comparing the achievable torque and power improvements yielded by constructing a retrofitted liquid cooling system for a COTS electric motor, it was found that, for a particular 100 W motor, 2.58-times higher current and torque output could be safely obtained with the liquid-cooled motor compared to the same motor with air cooling. This improvement factor closely matched the motor's thermal ratio, a theoretical value that can be directly calculated from datasheet motor parameters. Thus, the approach for implementing a maintainable liquid cooling has been empirically validated. An increase in continuous power output by a factor of two between the two cooling methods was also measured, and importantly, this increase fostered a mere 2.2% decrease in operating efficiency. This observation suggests that liquid cooling may also serve roles in actuators with strict energy consumption requirements, yet that are periodically required to produce high energy output.

The empirical measurement of the parameter R₂ is also useful in that it provides a data point for the performance of the heat convection in liquid-cooled COTS motors. Comparing the value of R₂ with liquid cooling (0.035 K/W) against its air-cooled counterpart (5.2 K/W) resulted in a reduction of thermal resistance by a factor of 160. This yields a data point of \sqrt{160}=12.6 for the thermal ratio of a “thermally-optimized” motor, where R₁≈0, meaning cooling fluid is passed directly over the windings. This value is, of course, related to the many factors associated with the particular liquid-cooled system, such as the outside surface area of the chosen 100-W motor, the size of the radiator, the number of cooling fans used, etc., and therefore is not a hard theoretical limit, only a single, empirically-derived data point.

In at least some embodiments of the present disclosure, the cooling system described above allows existing commercial off-the-shelf (COTS) electric motors to be cooled by liquid rather than air, solving the problem of low torque output by these types of electric motors. Due to the superior thermal properties of liquids, these liquid-cooled motors may be able to be operated at higher loads than air-cooled motors. In at least some embodiments, to facilitate improved cooling performance, ribs may be included in the design to limit the formation of eddy currents, which reduce fluid cooling performance. Unlike previous liquid-cooled motor designs, the designs described herein include the following two features:
The design facilitates the use of COTS motors. Many other liquid-cooled motor designs require the motor and the cooling system be designed together. By separating the two, the performance of COTS motors can be increased without having to completely redesign the motor from scratch.
The design facilitates maintenance, as it is designed for reuse and periodic cleaning. By integrating reusable O-rings into the cooling system's design, the liquid cooling jacket may be easily removed from the motor and cleaned without breaking any onetime seals. By contrast, other modular cooling systems are not designed to be easily removed. For example, current non-serviceable technology uses onetime seals and epoxies to produce a watertight barrier, meaning that the epoxies or sealants must be cut away to remove the cooling system.

Compared to current technologies, the design of the liquid cooling jacket described above may lead to lower maintenance costs for systems developed using this technology.

In some embodiments of the present disclosure, by incorporating series elastic actuators that use a viscoelastic material in compression, the position controllability of robotic actuators may be improved. Unlike in early rigid robots whose joints included only a motor and some type of gearbox, some robots include actuators that more closely mimic human muscles, which are not stiff, but are somewhat compliant. These actuators, called series elastic actuators, include elastic elements, typically implemented as mechanical compliance elements (such as springs) inside the actuators to achieve a softer response than in the early rigid robots.

The elastic element gives the series elastic actuators (SEAs) several unique properties compared to rigid actuators, including low mechanical output impedance, tolerance to impact loads, increased peak power output, and passive mechanical energy storage. In some embodiments of the present disclosure, the SEAs described herein may be efficient, compact, and light-weight, while meeting high power and force requirements.

Conventional SEA designs focus on obtaining an ideal (zero friction) spring behavior. In these designs, the passive output dynamics can be severely under-damped, any active damping may require high frequency, high motor effort, and the performance of the actuator (from a stability standpoint) may be limited by sensing and feedback delays. This conventional approach to series elastic actuation may also be very limited in terms of stiffness, which is largely due to the fact that the compliance for those actuators comes from a metal spring that is physically in series with the actuator. A metal spring is a pure elastic device that does not have any damping associated with it. Therefore, it does not dissipate energy very well. In general, conventional electric SEAs may exhibit relatively good efficiency, impact tolerance and force controllability, but poor position controllability, and power density. In some embodiments of the present disclosure, a variety of benefits may be realized by modifying the idea of series elastic actuators to include not only intentional elasticity, but also intentional damping.

As noted above, electrically powered SEAs typically contain an electric motor to generate mechanical power, a speed reduction element to amplify motor torque, a spring to sense force, and a transmission mechanism to route mechanical power to the output joint. Heat is generated when torque is produced by an electric motor. Therefore, the continuous power output of an electric actuator directly depends on the motor's thermal properties. However, a motor is able to generate torques greater than the thermally permissible continuous limit if done so for short periods of time. These intermittent torques often far exceed those which the speed reduction mechanism can support. Because of this discrepancy, the speed reduction mechanism is commonly the component which determines the peak output power capability of an actuator, rather than the motor. Additionally, the speed reduction mechanism is often a large source of loss in an electric actuator. Therefore, its selection can critically influence efficiency, as well.

For actuators with a fixed range of motion, the performance metrics also depend on actuator control strategies. Actuator power output is maximized when applying large torques at high velocities. Obtaining high velocities within a fixed range of motion requires short bursts of acceleration to and from rest. This requirement differs from those of continuous travel actuation schemes, whose maximum power output may be achieved simply with a viscous load and a step or ramp in the desired torque. For actuators with a fixed range of motion, the boundary conditions placed on high-power experiments necessitate the use of automatic control strategies to ensure the actuator operates within its permissible range of motion. It is then the combined performance of the hardware design and the control design which determines the usable power-to-weight ratio of the actuator.

In some cases, SEAs may be classified by their control strategies. For example, a control strategy for hardware designs using spring deflection sensors may treat a motor as a velocity source, and transform desired spring forces into desired spring deflections. However, for hardware designs using strain gauges, the force sensor does not output an intermediate displacement value, but maps changes in resistance directly to applied force. For such a system, modeling the motor as a force source may be more convenient. In some cases, the classification of SEA control strategies may be made based on the types and combinations of control structures used. For example, some controllers measure the spring force and control motor force using a subset of proportional-integral-derivative (PID) control structures (e.g., P, PD, etc.). Another class of controllers use PID control but also consider the dynamics of the mechanical system to improve the frequency response of force control. Still others use PID, model-based, and disturbance observer (DOB) structures together to achieve impressive torque tracking performance. In the discussions that follow, actuator performance may be defined by a combination of metrics that include measured power-to-weight ratio, force tracking accuracy and bandwidth, position tracking accuracy and bandwidth, and actuation efficiency.

Although the increasing use of SEAs has resulted in devices that are safe for operation in close proximity to humans, these devices are in some cases not very useful because of their poor performance. This poor performance is due, in part, to the fact that the elastic elements in conventional SEAs do not contain a stabilizing component for damping. Since the elastic element does not damp the behavior of the actuator, it cannot do anything to stop its behavior. In some existing robots, an electronic control law may be applied (e.g., in software) that measures the velocities of the actuators. However, using this approach, it can be very difficult to achieve the desired performance of the physical device. Instead, in at least some embodiments of the present disclosure, a series elastic actuator may be stabilized not using software, but using a viscoelastic material. Viscoelastic materials are those materials that, like ligaments and tendons, exhibit both elastic characteristics and viscous characteristics (which may provide damping) when stress is applied. For example, a stress that is applied briefly to these materials (and then quickly removed) may cause a temporary deformation of the material, while a stress that is maintained over a long period of time may cause a permanent deformation of the material. Some examples of viscoelastic materials include amorphous polymers, semicrystalline polymers, biopolymers, metals at very high temperatures, and bitumen materials. The use of viscoelastic materials in SEAs may lead to a new generation of safe robots that are much more precise than previously developed robots without having an unduly complicated embedded system and control system.

In some embodiments of the present disclosure, viscoelasticity may be achieved using a polyurethane elastomer (which may be considered a type of plastic or rubber) in place of the metal springs in a conventional SEA, as this material exhibits both elasticity and damping properties. In such embodiments, the mechanical construction of the device may include sandwiching two pieces of this material together, putting them in compression with each other within the device.

In at least some embodiments, the techniques described herein may be used to create actuators that allow for precise force control and overcome the deficiencies of prior SEAs in terms of position control, resulting in an actuator that is efficient, compact, and light-weight, while meeting high power, precision, and force requirements. These series elastic actuators may include a motor, a drivetrain transmission, and an elastic element. In some embodiments, the elastic element is placed in series with the motor and drivetrain transmission, and is positioned between the actuator housing and the chassis ground so as to support and measure the force generated by the actuator. A position-sensing element is mounted on the actuator and connected to the elastic element so as to measure any deflection of the elastic element. The position sensing element generates a signal, based on the deflection of the elastic element, that indicates the force experienced by the actuator. This signal is then transmitted to a controller for the motor, creating an active feedback force control loop. The result is an ability to continuously and precisely maintain a desired actuator force at the output by adjusting the motor output to compensate for the variable forces experienced by the actuator. The described mechanism also ensures that the actuator is shielded from impact loads.

There are two common arrangements of components found in SEA designs. The first arrangement, which is referred to herein as a force sensing series elastic actuator (FSEA), places the compliant element between the gearbox output and the load. The second arrangement, which is referred to herein as a reaction force sensing series elastic actuator (RFSEA), places the spring between the motor housing and the chassis ground.

FIGS. 7A and 7B schematically illustrate these two different arrangements of the components of a series elastic actuator, according to at least some embodiments. More specifically, FIG. 7A illustrates an example embodiment of a Force Sensing Series Elastic Actuator (FSEA) 700. In this example embodiment, FSEA 700 includes a motor 702, a gearbox 704, an elastic element 706, and an output 708. In this example embodiment, the elastic element 706 is positioned between the output of gearbox 704 and the output (load).

FIG. 7B illustrates an example embodiment of a Reaction Forces Sensing Series Elastic Actuator (RFSEA) 750. In this example embodiment, RFSEA 750 includes an elastic element 756, a motor 752, a gearbox 754, and an output 758. In this example, elastic element 756 is positioned between motor 752 and the chassis ground.

In at least some embodiments, RFSEA style actuators may have the advantage (over FSEA style actuators) of being more compact, since the compliant element does not have to travel with the load. Instead, it may be placed statically behind the actuator, or it may even be remotely located, in some embodiments. Prismatic RFSEAs may also have a greater range of motion for a given ball screw travel length compared to prismatic FSEAs, but RFSEAs may exhibit less direct force sensing, reduced force tracking performance, and decreased protection from impact loads. In several of the example systems described herein, an RFSEA style design was included to minimize the bounding volume of the actuator. However, this design decision was heavily influenced by the selection of the pushrod/ball screw drivetrain. In other embodiments, FSEA style actuators may be more suitable for a particular application.

In conventional SEA designs, the spring stiffness may be chosen to maximize energy storage. For a given force, soft springs are able to store more energy than stiff springs. The design specifications for the springs of a conventional SEA design may include the expected peak force, the desired deflection (maximum possible deflection to minimize stiffness), and the geometric constraints of the actuator. In one example, a spring for a conventional SEA (more specifically, a pushrod RFSEA-style actuator) was designed and manufactured to have a stiffness rate of 138 N/mm, which effectively doubles to 277 N/mm for the actuator spring constant because the SEA uses two springs with pre-compression. In various embodiments of the present disclosure, the springs in these and other types of SEAs may be replaced with a viscoelastic element, as described herein, which may improve the position controllability of the SEA. Several examples of SEAs to which this approach may be applied, and various models of these devices, are described below.

### Modeling

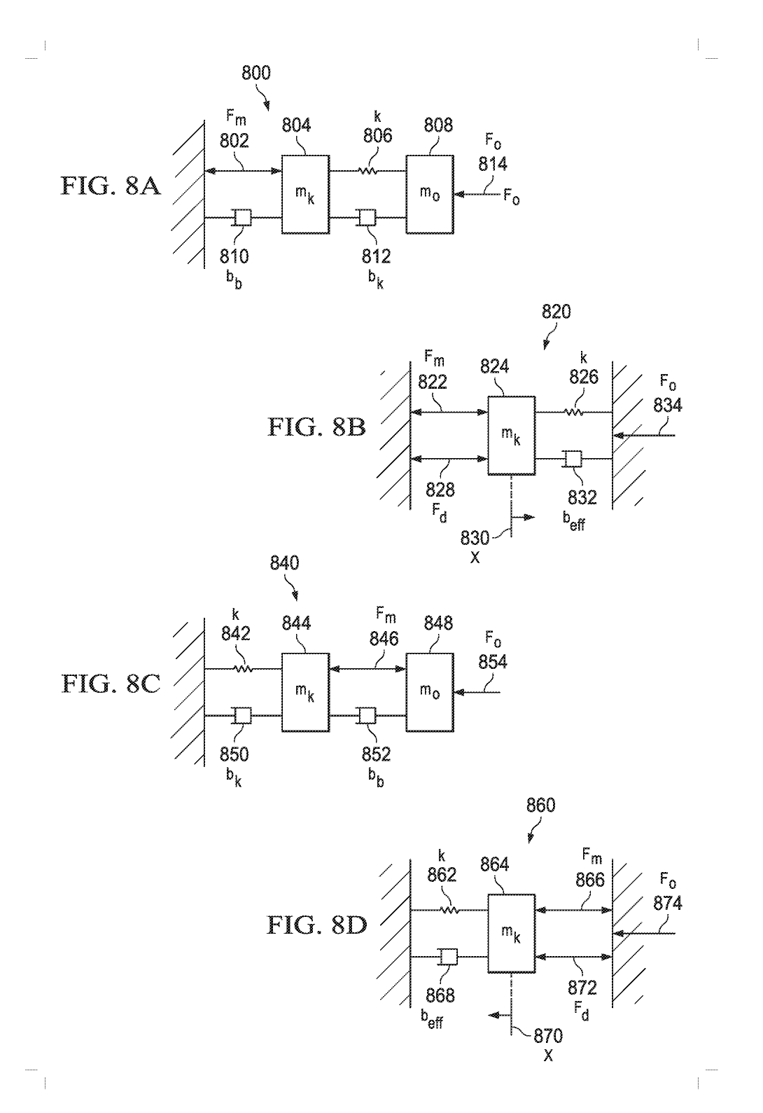

FIGS. 8A-8D illustrate models for different series elastic actuators, according to at least some embodiments. More specifically, FIG. 8A illustrates an example embodiment of an FSEA model 800. In this example, model 800 includes an element representing the motor force (Fₘ 802), an element representing the output force (Fₒ 814), an element representing viscous back-driving friction (b_{b} 810), an element representing viscous spring friction (bₖ 812), an element representing the lumped sprung mass (mₖ 804), an element representing the output mass (mₒ 808), and an elastic element 806 with spring constant k. In this FSEA model, the generalized motor force (Fₘ 802) is generated between the chassis ground and the lumped sprung mass (mₖ 804), which includes rotor inertia, the gearbox reduction, and transmission inertia. If the motor is unpowered and back-driven, a viscous back-driving friction (b_{b} 810) is felt from transmission friction and motor friction. In this FSEA model, the spring 806 is between the transmission output and output mass (mₒ 808) and has stiffness (k) and viscous friction (bₖ 812) generated by the spring support mechanism.

FIG. 8C illustrates an example embodiment of an RFSEA model 840. In this example, model 840 includes an element representing the motor force (Fₘ 846), an element representing the output force (Fₒ 854), an element representing viscous back-driving friction (b_{b} 852), an element representing viscous spring friction (bₖ 850), an element representing the lumped sprung mass (mₖ 844), an element representing the output mass (mₒ 848), and an elastic element 842 with spring constant k. In this RFSEA model, positions of the spring 842 and force generating elements (motor force Fₘ 846) are switched. In addition, the distribution of the sprung mass (mₖ 844) and output mass (mₒ 848) is different for the RFSEA model than for the FSEA model illustrated in FIG. 8A and described above. In this RFSEA model, the output mass (mₒ 848), includes rotor inertia, the gearbox reduction, and transmission inertia. Here, the lumped sprung mass (mₖ 844) varies by the design. In one example SEA embodiment described herein, the lumped sprung mass (mₖ 844) includes the mass of the actuator housing and motor, including the rotor mass.

A high-output impedance model may be useful for simplifying the force controller design problem. For example, this type of model may assume that the actuator output is rigidly connected to an infinite mass, which cannot be moved.

FIG. 8B illustrates an example embodiment of an FSEA high output impedance model 820. In this example, model 820 includes an element representing the motor force (Fₘ 822), an element representing the output force (Fₒ 834), an element representing the lumped sprung mass (mₖ 824), an elastic element 826 with spring constant k, an element representing lumped damping (b_{eff} 832 which equals b_{b}+bₖ), and an element representing disturbance forces and/or other forces that are difficult to model (F_{d} 828). These forces may include, for example, the torque ripple from commutation, the torque ripple from the gearbox due to teeth engaging and disengaging, backlash, and various forms of friction such as stiction and coulomb friction. In this example, the element x (830) represents the spring deflection.

FIG. 8D illustrates an example embodiment of an RFSEA high output impedance model 860. In this example, model 860 includes an element representing the motor force (Fₘ 866), an element representing the output force (Fₒ 874), an element representing the lumped sprung mass (mₖ 864), an elastic element 862 with spring constant k, an element representing lumped damping (b_{eff} 868 which equals b_{b}+bₖ), and an element representing disturbance forces and/or other forces that are difficult to model (F_{d} 872). In this example, the element x (870) represents the spring deflection.

One of the relevant differences between FSEAs and RFSEAs is that accurate force sensing for RFSEAs requires knowledge of the spring constant, lumped damping, lumped spring mass, and derivatives of the spring deflection, whereas force sensing for FSEAs only requires knowledge of the spring constant and spring deflection for a close approximation of the output force. Another difference is that the output force of an FSEA can safely track a reference force signal up to and past resonant frequencies, but requires large motor effort at high frequencies. RFSEAs, on the other hand, cannot safely track references force signals close to their resonant frequencies due to large resonant spring forces, but can track high-frequency force signals with low motor effort. A third difference is that in FSEAs, a mechanical low-pass filter is placed between the output and the gearbox, making them more tolerant to impact forces than RFSEAs. Based on these observations, FSEAs may be better suited for force control applications. However, the excellent size and packaging characteristics of RFSEAs may outweigh the tradeoffs in force controllability for some applications.

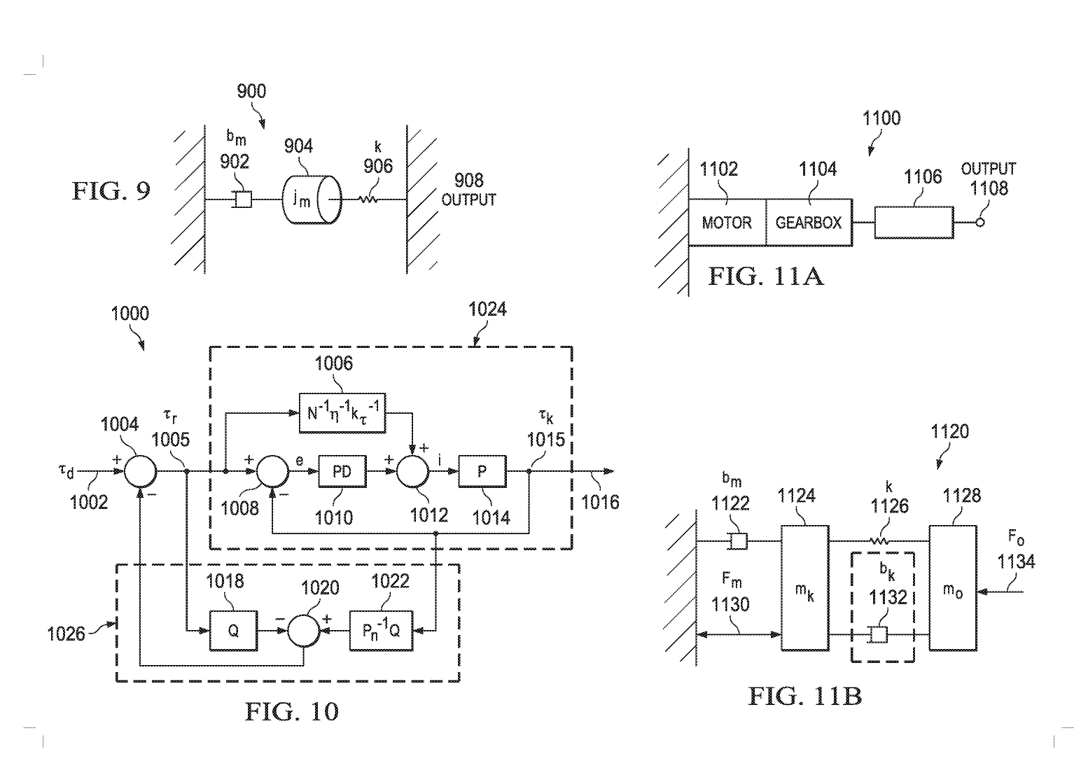

The techniques described herein for improving position controllability by modifying series elastic actuators to include not only intentional elasticity, but also intentional damping, may be applied to any of the FSEA and/or RFSEA designs described herein, as well as to other types of actuators, at least some of which are suitable for use in robotics applications. A plant model of another example SEA design is illustrated in FIG. 9. More specifically, FIG. 9 illustrates a circuit model 900 of a locked-output series elastic actuator (SEA), according to at least some embodiments. In this example embodiment, locked-output SEA model 900 includes an element representing motor damping (bₘ 902), an element representing motor inertia (jₘ 904, with motor torque τₘ and motor angle θ, an elastic element 906 with spring constant (spring stiffness) k, and an element representing the output (output 908, with spring torque τₖ). In this model, the relation between the torque applied to the spring (motor torque τₘ) and spring deflection (motor angle θ) is a second order dynamic system with jₘ 904 representing the effective motor inertia felt by the spring, bₘ 902 representing the effective motor-side damping felt by the spring, and k representing spring stiffness.

### Force Control

In the example embodiment described herein, the control plant may be an SEA with a locked output, as shown in FIG. 9. The force controller may include an inner PD compensator that is tuned to produce the desired frequency response based on this locked-output assumption. A disturbance observer (DOB) may be included to reject deviations from this nominal locked-output model and to maintain torque tracking accuracy. In some embodiments, a DOB of such a force controller may be designed based on an analytical model of the inner PID (or PD) control loop. In other embodiments, it may be designed using a model obtained from experimental system identification.

FIG. 10 illustrates an example torque controller 1000 for a robotic actuator, according to at least some embodiments. In some embodiments, torque controller 1000 may be used for closed-loop system identification. In this example embodiment, the closed-loop torque-tracking transfer function (P_{c} 1024, from input τ_{d} 1002 to output τₖ at 1015 and 1016) includes a feed-forward term 1006 and a feedback term (PD 1010). The feed-forward term 1006 may be used to scale desired actuator torques 1002 into approximate actuator output torques 1016 to minimize control effort from the feedback term (PD 1010). In this example, the feed-forward term 1006 is dependent on the inverses of the motor speed reduction N, the drivetrain efficiency η, and the motor torque constant k_{τ}. The feedback term is represented by a transfer function implemented by a PD compensator, as described above.

In this example embodiment, torque controller 1000 also includes a distance observer (DOB 1026), summing junctions 1004, 1008, 1012, and 1020, and a physical actuator (SEA 1014), which takes as input the motor current i and produces spring deflection (τₖ 1015/1016) as an observable output. In this example, the two Q functions within DOB 1026 (e.g., Q 1018 and the Q function within element 1022) are low-pass filters. In this example, the output of summing junction 1004, shown as τᵣ 1005, is an input to Q function 1018.

In at least some embodiments of the present disclosure, a DOB may be used to 1) measure and compensate for error from disturbances; and 2) reduce the effect of plant modeling error. To use a DOB, a nominal plant model is required. In the example embodiment illustrated in FIG. 10, the DOB plant is the closed-loop transfer function (P_{c} 1024) created by the PD controller 1010. In some embodiments, if the spring torque τₖ, motor current i, speed reduction N, drivetrain efficiency η, and motor torque constant k_{τ} are known, the control plant P from motor current to spring torque can be found. Assuming the spring constant is calibrated beforehand, it may be possible to determine all of the remaining parameters of the torque controller using system identification techniques with the actuator output locked.

In at least some embodiments of the actuators described herein, the position controller may build upon the force controller. However, for position control, it may no longer be assumed that the actuator is in a high-impedance configuration. While moving from a high-impedance configuration changes the plant of the force controller, experimental tests of the position controller show high tracking accuracy and large bandwidth.

In at least some embodiments of the present disclosure, a compact, lightweight, high power actuator may be suitable for use in the next generation of electrically actuated machines. These SEAs may feature a tightly integrated pushrod design, which allows the actuator to be housed within a robotic limb, and may use a nonlinear mechanical linkage to drive a rotary joint. High motor voltage and current filtering may enable the use of a large speed reduction which significantly increases both continuous and peak torque capabilities. Placement of the elastic element between the actuator housing and chassis ground may create a design with increased range of motion and small size. In at least some embodiments, the elastic element may include a viscoelastic material (such as neoprene, polyurethane, silicone, rubber, etc.), rather than rigid springs. In such embodiments, there may be no feedback from deflection and no feed-forward control.

The selection of a viscoelastic material to be used in a particular series elastic actuator may be based on the properties of the materials and the applications in which the actuators will be implemented, with different mixes of traits being desirable for different applications. In some applications, a large amount of force may be placed on the viscoelastic material, and not all of the many different types of viscoelastic materials available can withstand the expected amount of force. For some applications, it may be important to select a material that has an appropriate amount of stiffness for a particular application. In one example robotic application, the viscoelastic material may need to withstand forces up to 1000 N with displacements of 14 mm. However, for a different application (e.g., one with lighter load requirements), the material selection may be completely different.

In some embodiments, the selection of a viscoelastic material to be used in a particular series elastic actuator may be based, at least in part, on hysteresis, which is the gap between when the material is compressed and when it is decompressed. This may also be application dependent. For example, for some applications it may be important to have more knowledge about the force that is going to be exerted. In such applications, the less hysteresis there is, the more the viscoelastic material behaves like an ideal spring, and the more insight be may gained into the amount of force that is actually being exerted. However, for applications in which the damping properties are more important than the introspection about the force being exerted, a different material may be chosen. In some embodiments, the selection of a viscoelastic material to be used in a particular series elastic actuator may be based, at least in part, on the hardness of the material. For example, the hardness range for polyurethane may be from about 10 A to 75 D. When selecting a material that needs to withstand a large amount of force, it may be important that the material does not disintegrate when it is squeezed as much as it will be squeezed in the target application. In general, the selection of the viscoelastic material (and its damping properties) may be dependent on the required load. For example, for an actuator used in heavy construction equipment, with very heavy loads on the actuators (e.g., for digging in the earth, etc.), the primary considerations for material selection may be more about damping and being able to position the device where it needs to be and less about safety and compliance. In contrast, for an actuator in a humanoid robot that is hugging a human, the material may not need to handle a large load, and the primary considerations for material selection may be more about safety and compliance (e.g., more like the properties of an ideal spring).

FIG. 11A illustrates an example viscoelastic actuator 1100, according to one embodiment. In this example embodiment, viscoelastic actuator 1100 includes a motor 1102, a gearbox 1104, an elastic element 1106 (made, in at least some embodiments, of rubber), and an output 1108.

FIG. 11B illustrates an approximate circuit model 1120 for the viscoelastic actuator shown in FIG. 11A, according to one embodiment. In this example embodiment, the approximate viscoelastic actuator model 1120 includes an element representing motor damping (bₘ 1122), an element representing the lumped sprung mass (mₖ 1124), an elastic element (1126) with spring constant (spring stiffness) k, an element representing the output mass (mₒ 1128), an element representing the motor force (Fₘ 1130), an element representing viscous spring friction (bₖ 1132), and an element representing the output force (Fₒ 1134). At least some of these elements may be the same as or similar to the corresponding elements illustrated in FIG. 8A as described above.

### Example Actuator Designs

In at least some embodiments of the actuators described herein, a motor may be mounted directly to the actuator housing and may be connected by a drive belt to a component of the actuator body, such that the component rotates along with the motor. This component may be in contact with a ball screw via a ball nut, and the ball screw may be housed inside the main actuator body. The rotation of the component may slide the ball screw in and out, like a piston, depending on the direction of the rotation. The ball screw may be secured inside the main actuator body by a piston-style ball screw support, which allows for stability and compactness. Four linear guides may be positioned along the length of the main actuator body, each of which is connected to the main actuator body via ball bearings, such that the main actuator body can collapse inward or expand outward along the linear guides.

In one embodiment, the position-sensing element may be an optical or magnetic encoder. In other embodiments, the position-sensing element may be a potentiometer. The position-sensing element may be connected to the elastic element by way of a cable. In some embodiments, the elastic element may consist of a spring that is wrapped around the main actuator body for compactness. In other embodiments, the elastic element may be implemented using a viscoelastic material, portions of which are in compression, as described herein. Pulleys may be attached to the main actuator body, where the pulleys are connected to the cable in such a way that the pulleys may rotate, with the degree of rotation being a function of the collapse or expansion of the main actuator body. The position-sensing element may measure this rotation and generate a signal that communicates the measurement, and the signal may be used to calculate the collapse or expansion of the main actuator body. An encoder, located at the motor output on the main actuator body, may be used to measure the speed of the motor. These measurements may be used to adjust the position of the motor, and thereby the distance that the ball screw slides, in response to forces applied at the load end of the ball screw. An absolute encoder may be used to initialize the actuator's output position.

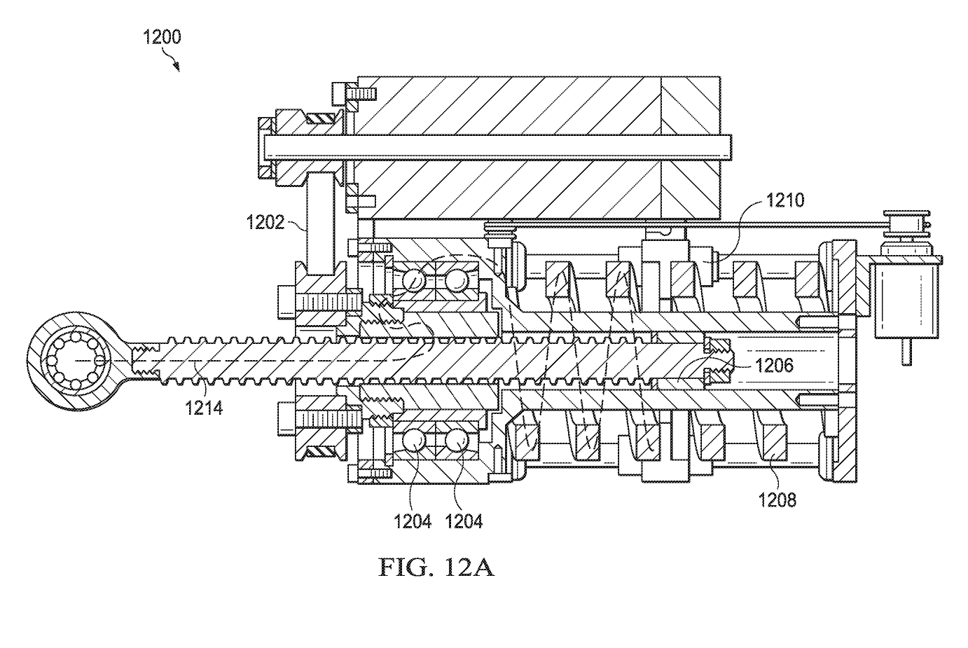

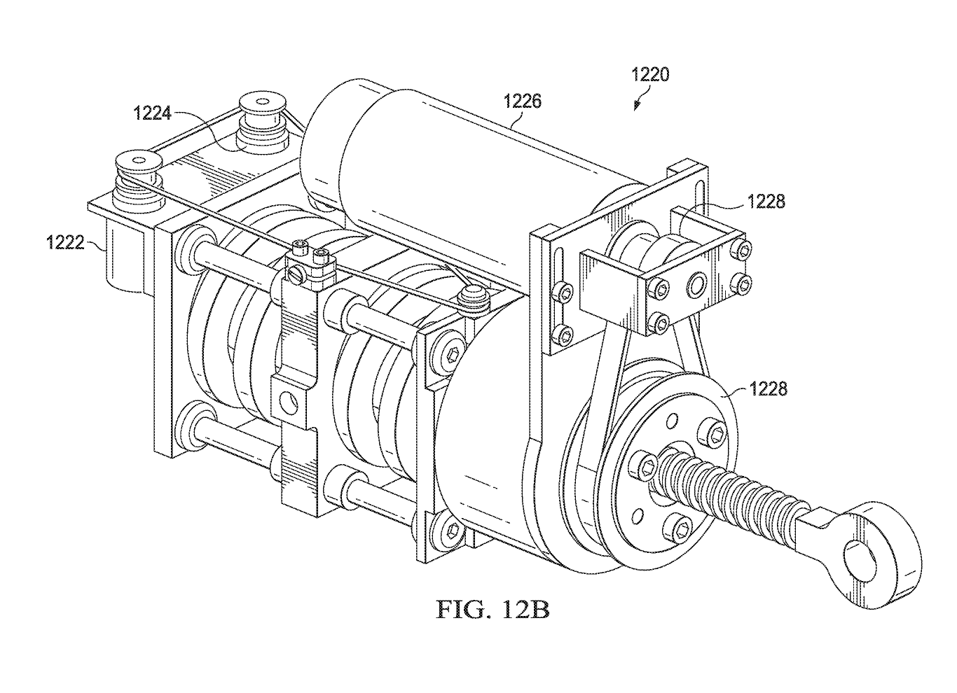

FIGS. 12A and 12B illustrate different views of an example series elastic actuator (SEA), according to one embodiment. More specifically, FIG. 12A illustrates a physical cross-section 1200 of an example SEA and its constituent components. In this example embodiment, the label 1202 identifies a low backlash timing belt (pulley), the label 1204 identifies angular contact ball bearings, the label 1206 identifies a piston-style ball screw support mechanism, the label 1208 identifies the elastic elements, which in this illustration includes high-compliance springs, and the label 1210 identifies miniature ball bearings that serve as a linear guide. In other embodiments, the springs illustrated in FIG. 12A may be replaced with a viscoelastic material in compression, as described herein, which may improve the position controllability of the SEA. In the illustrated example, the label 1214 identifies the load path, which is in compression.

FIG. 12B illustrates an exterior view 1220 of the SEA shown in FIG. 12A. In this example embodiment, the label 1226 identifies a brushless DC motor, the label 1228 identifies a pulley drivetrain that effects a 3:1 speed reduction, the label 1222 identifies an absolute encoder that serves as a position sensor, and the label 1224 identifies an incremental encoder that serves as a position sensor.

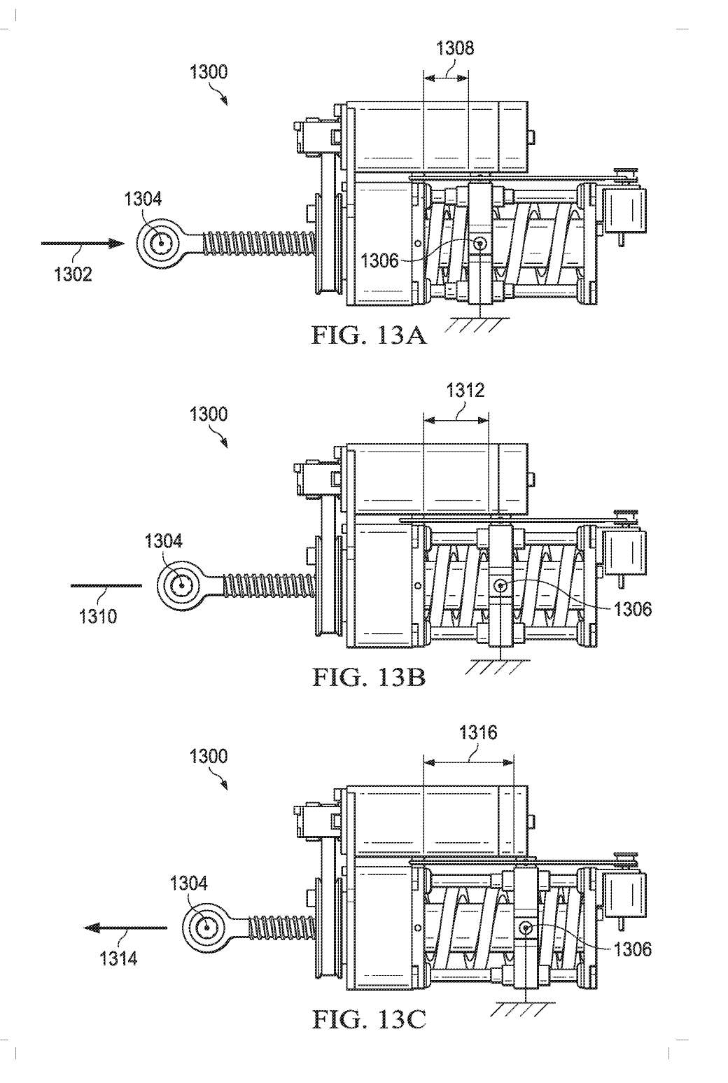

FIGS. 13A-13C illustrate the deformation of an elastic element of an example series elastic actuator (SEA) 1300 under different loading conditions, according to one embodiment. In this example embodiment, the elastic element includes metal springs. In other embodiments, the metal springs may be replaced with a viscoelastic material in compression, as described herein, which may improve the position controllability of the SEA.

For the actuator illustrated in FIGS. 13A-13C, the actuator displacement may be defined as the distance between points 1304 and 1306. In at least some embodiments of the present disclosure, this distance remains constant while the spring deflection, x, depends on the actuator force, F. In at least some embodiments of the present disclosure, the elastic element includes two springs that are, essentially, pre-loaded against each other so that they are always in compression. In FIG. 13A, the force F (1302) is a positive force, and the actuator is pushing to the right. Therefore, the spring on the left is compressed, and the spring deflection, x, is shown at 1308. In FIG. 13B, the force F (1310) is zero, and the actuator is not pushing (nor is it pulling) in any direction. Here, the spring deflection, x, is shown at 1312. In FIG. 13C, the force F (1314) is a negative force, and the actuator is pulling to the left. Therefore, the spring on the right is compressed, and the spring deflection, x, is shown at 1316.

In embodiments in which the metal springs shown in FIGS. 13A-13C are replaced with a viscoelastic material, there may be two portions of the viscoelastic material in the actuator. If, as in FIG. 13A, the force F (1302) is a positive force, and the actuator is pushing to the right, the portion of the viscoelastic material on the left may be deformed (compressed). If, as in FIG. 13B, the force F (1310) is zero, and the actuator is not pushing (nor is it pulling) in any direction, neither portion of the viscoelastic material may be deformed. If, as in FIG. 13C, the force F (1314) is a negative force, and the actuator is pulling to the left, the portion of the viscoelastic material on the right may be deformed (compressed).

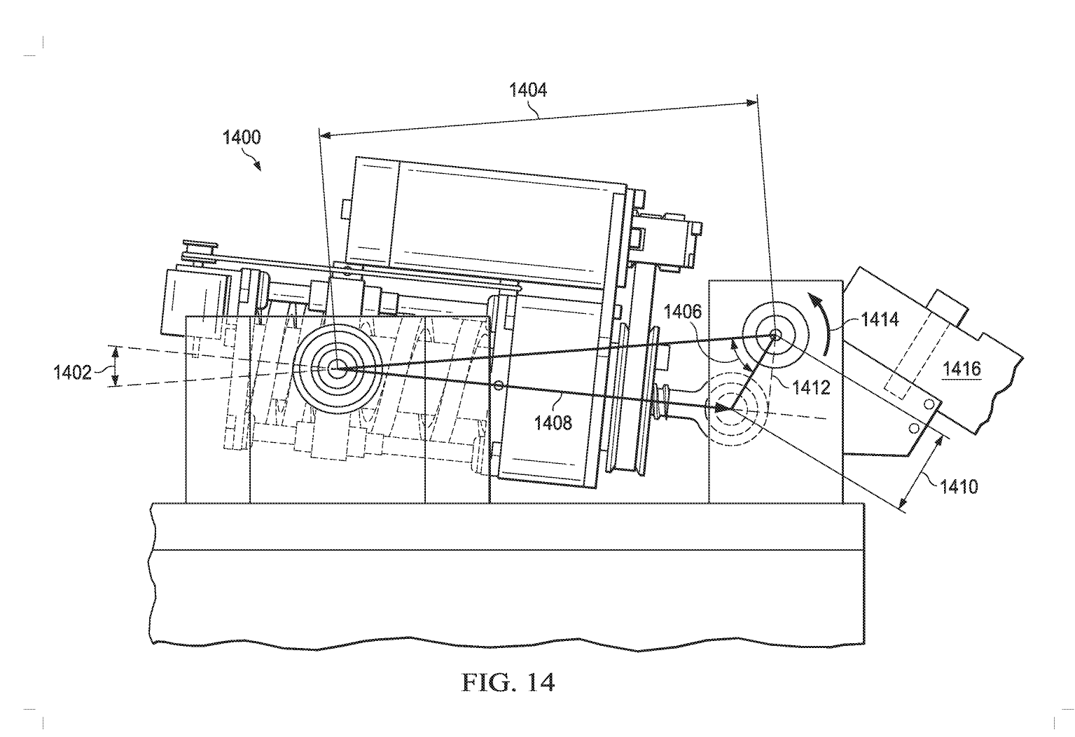

FIG. 14 illustrates the use of a series elastic actuator to drive a rotary joint, according to one embodiment. More specifically, FIG. 14 illustrates a test bench 1400 on which a SEA is mounted, with the prismatic linkage geometry of the SEA shown. In at least some embodiments of the present disclosure, the elastic element within the SEA (not shown) may be a viscoelastic material in compression, as described herein. In this example embodiment, the label 1412 identifies the linkage moment arm, the label 1404 identifies the distance between the actuator pivot and the arm pivot, the label 1410 identifies the distance between the arm pivot and the pushrod pivot, the label 1408 identifies the actuator force F, label 1414 identifies the torque τₐ exerted on the output arm, label 1406 identifies the output arm angle θₐ, the label 1416 identifies the inertia of the output arm Jₐ, and the label 1402 identifies the offset angle φ.

In this example test bench, by using the aforementioned force controller as the innermost component of the position controller, the actuator may be treated as a nearly ideal force source. In this example embodiment, this force source generates a torque through a mechanical linkage with a moment arm 1412 as depicted in FIG. 14. The actuator force F (1408) generates an arm torque (τₐ) that is dependent on the arm angle (θₐ), the inertia of the output arm Jₐ (1416), the joint friction (not shown) and/or the torque due to gravity (not shown). The torque due to gravity may be parameterized by the mass of the output link (not shown), the distance from the point of rotation to the center of mass (not shown) and the offset angle φ (1402) to correct for the distance between the actuator pivot and the arm pivot (1404) not being orthogonal to the gravity vector.

In some embodiments of the present disclosure, a series elastic actuator may include both a maintainable liquid cooling jacket and a viscoelastic element in compression, the combination of which may make these SEAs particularly well suited for use in robotic actuators, although other applications may benefit from the application of these two improvements over a conventional SEA.

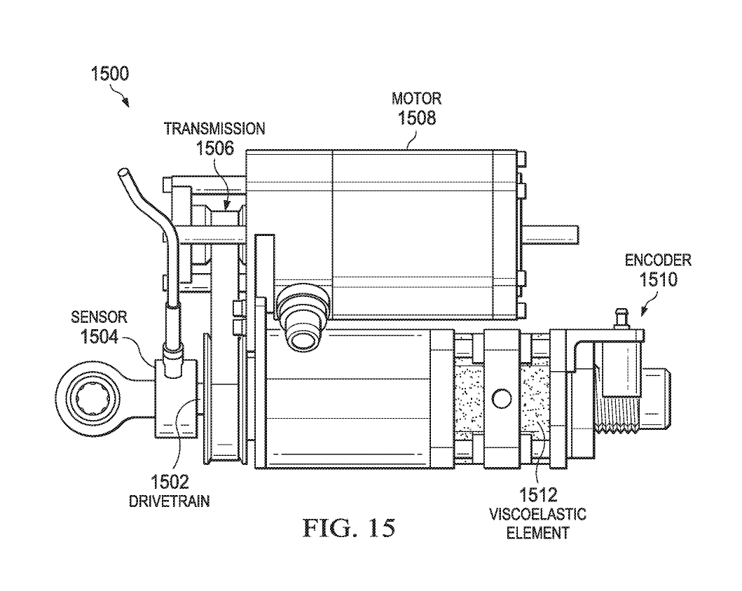

FIG. 15 illustrates an example viscoelastic liquid-cooled actuator (VLCA 1500), according to one embodiment. In this example embodiment, VLCA 1500 includes a low friction ball screw drivetrain 1502, a force sensor 1504, a high efficiency pulley transmission 1506, a liquid-cooled electric motor 1508 (which may be the same as or similar to the liquid-cooled motor illustrated in FIGS. 2A-2C), a viscoelastic element 1512, and an encoder 1510 for measuring the viscoelastic deflection.

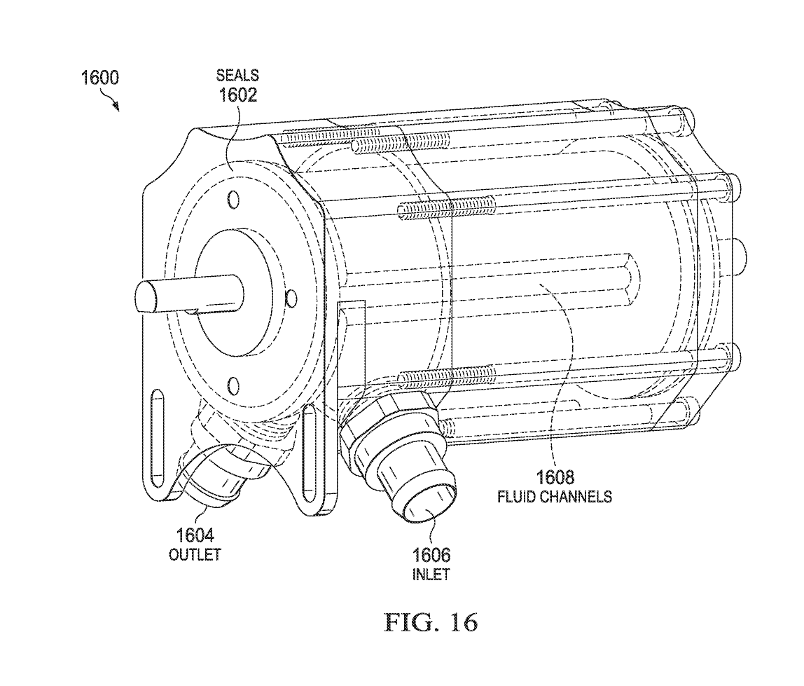

FIG. 16 illustrates, in more detail, an example liquid-cooled motor (such as liquid-cooled motor 1508 of VLCA 1500 shown in FIG. 15), according to one embodiment. In this example embodiment, liquid-cooled motor 1600 includes one or more O-ring fluid seals 1602, an outlet fitting 1604, an inlet fitting 1606, and internal fluid channels 1608. In at least some embodiments, this liquid-cooled motor design may exhibit on the order of 1.55× the power density of a corresponding existing air-cooled SEA, and on the order of 2× the force (torque) density of the existing air-cooled design.

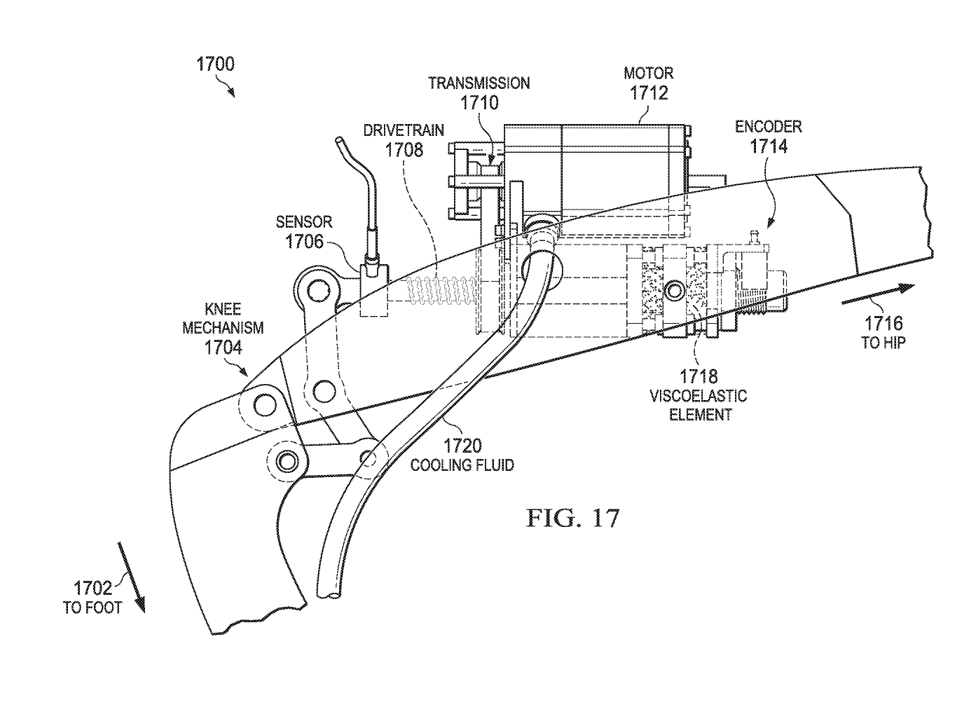

FIG. 17 illustrates the use of a VLCA in a robotic leg 1700, according to one embodiment. In this example embodiment, the robotic leg 1700 includes a nonlinear knee mechanism 1704, which is controlled by the VCLA to extend and retract the lower leg at the knee. Robotic leg 1700 includes a force sensor 1706, a low friction ball screw drivetrain 1708, a high efficiency pulley transmission 1710, a liquid-cooled electric motor 1712 (which may be the same as or similar to the liquid-cooled motor illustrated in FIGS. 2A-2C), cooling fluid 1720, a viscoelastic element 1718, and an encoder 1714 for measuring viscoelastic deflection. Robotic leg 1700 may also include an element 1716 that connects the portion of robotic leg 1700 illustrated in FIG. 17 to a robotic hip (not shown), which may or may not be controlled by another VLCA, in different embodiments. Robotic leg 1700 may also include an element 1702 that connects the portion of robotic leg 1700 illustrated in FIG. 17 to a robotic foot (not shown), which may or may not be controlled by another VLCA, in different embodiments

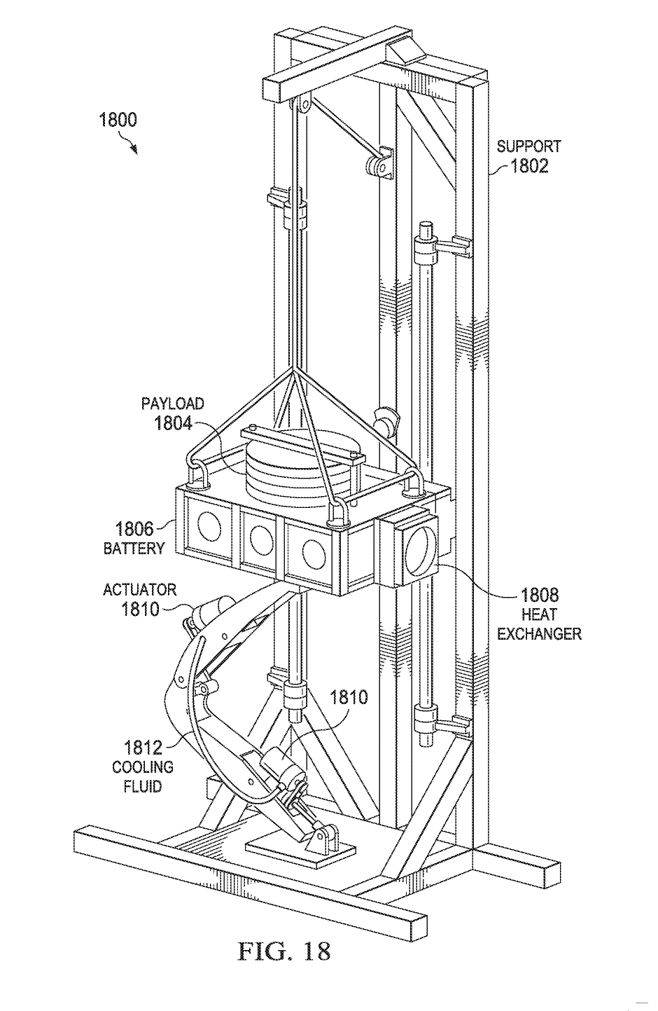

FIG. 18 illustrates an example two-degree-of-freedom VLCA test bed 1800, according to one embodiment. In this example embodiment, VLCA test bed 1800 includes a support structure 1802, a battery 1806 (which, in some embodiments, may be a 500 watt-hour lithium ion battery), a heat exchanger 1808, two VCLAs 1810 (either or both of which may be the same as or similar to the VLCA illustrated in FIG. 15), cooling fluid 1812, and a payload 1804.

In these and other applications of series elastic actuators in robotic applications, a viscoelastic material may be used in place of rigid metal springs to provide damping, and thus to stabilize the SEAs. As described herein, in at least some embodiments of the present disclosure, a robotic actuator may contain a viscoelastic elastomer (or another suitable viscoelastic material) that is installed in series with the load path. The use of this viscoelastic material may increase the actuator's robustness to shock loads while maintaining high fidelity position and velocity control. In contrast to other work with series viscoelastic components, the SEAs described herein may use elastomer-based viscoelastic elements in compression rather than in tension or in torsional shear. In at least some embodiments, this technology may solve the problem of low maximum output impedance in prismatic series elastic actuators, and may increase the control system stability for prismatic series elastic actuators. Due to the inherent damping of elastomers compared to traditional metal springs, the output of elastomer-equipped prismatic series elastic actuators may be controlled in a more stable fashion. In general, any application requiring actuation that is robust to impact loads and is capable of a wide range of output impedances may benefit from this apparatus.

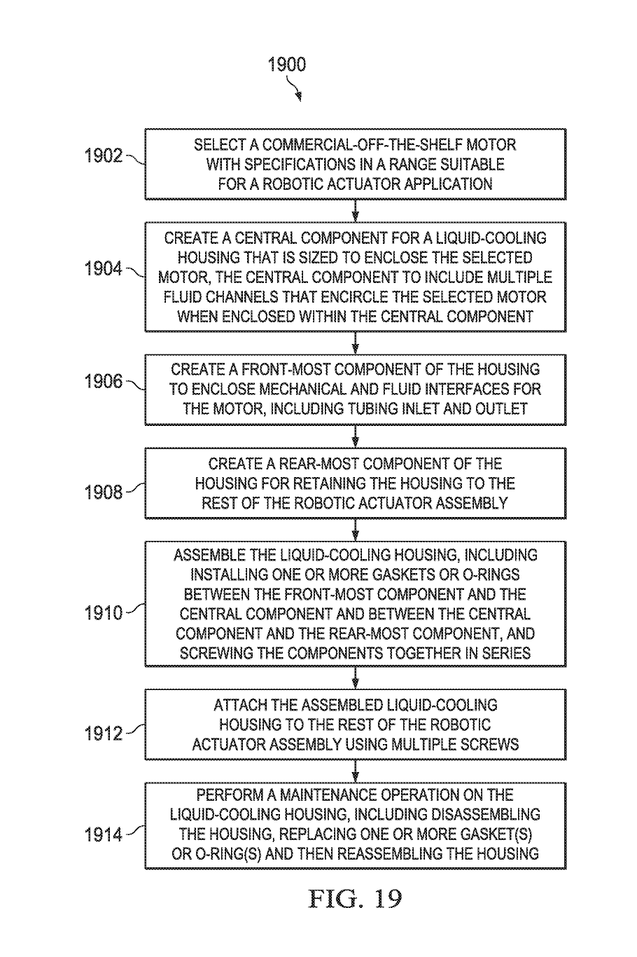

FIG. 19 illustrates selected elements of an example method 1900 for providing liquid cooling for a commercial off-the-shelf motor, according to at least one embodiment. The steps of method 1900 may begin at any suitable point, including 1902. Furthermore, the steps of method 1900 may be optionally repeated, looped, recursively executed, executed in various order, or omitted as necessary. Different steps of method 1900 may be executed in parallel with other steps of method 1900. In additional, further steps may be executed during execution of method 1900, wherein such further steps are not shown in FIG. 19 but are described herein or would be apparent to one of skill.

In this example embodiment, the method includes (at 1902) selecting a commercial off-the-shelf motor having datasheet specifications in a range suitable for a robotic actuator application. The method includes (at 1904) creating a central component for a liquid-cooling housing that is sized to enclose the selected motor, where the central component includes multiple fluid channels that encircle the selected motor when it is enclosed within the central component. For example, in some embodiments, the central component may be created using 3D printing. In other embodiments, it may be created by machining a polymer, resin, plastic or other material of suitable strength and weight, and having other properties suitable for the application. In still other embodiments, the central component may be created using an injection-molding process.

In this example embodiment, the method includes (at 1906) creating a front-most component of the housing to enclose the mechanical and fluid interfaces for the motor, including an inlet and an outlet for the tubing to carry the cooling liquid. As with the central component, the front-most component may be created using 3D printing, by machining a polymer, resin, plastic or other material of suitable strength and weight, and having other properties suitable for the application, or using an injection-molding process, in different embodiments. The method also includes (at 1908) creating a rear-most component of the housing for retaining the housing to the rest of the robotic actuator assembly. As with the central component, the rear-most component may be created using 3D printing, by machining a polymer, resin, plastic or other material of suitable strength and weight, and having other properties suitable for the application, or using an injection-molding process, in different embodiments.

In this example embodiment, the method includes (at 1910) assembling the liquid-cooling housing, which includes installing one or more gaskets or O-rings between the front-most component and the central component and between the central component and the rear-most component, and screwing the components together in series, as illustrated in some of the examples described herein. The method also includes (at 1912) attaching the assembled liquid-cooling housing to the rest of the robotic actuator assembly using multiple screws.

At some point in time after the liquid-cooling housing has been assembled and the motor it encloses has been put into operation, maintenance may be required for the liquid-cooling housing. For example, one or more of the gaskets or O-rings of the liquid-cooling housing may need to be replaced. As illustrated in the example embodiment shown in FIG. 19, in this case, the method includes (at 1914) performing a maintenance operation on the liquid-cooling housing, which includes disassembling the housing, replacing one or more of the gasket(s) or O-ring(s) and then reassembling the housing.

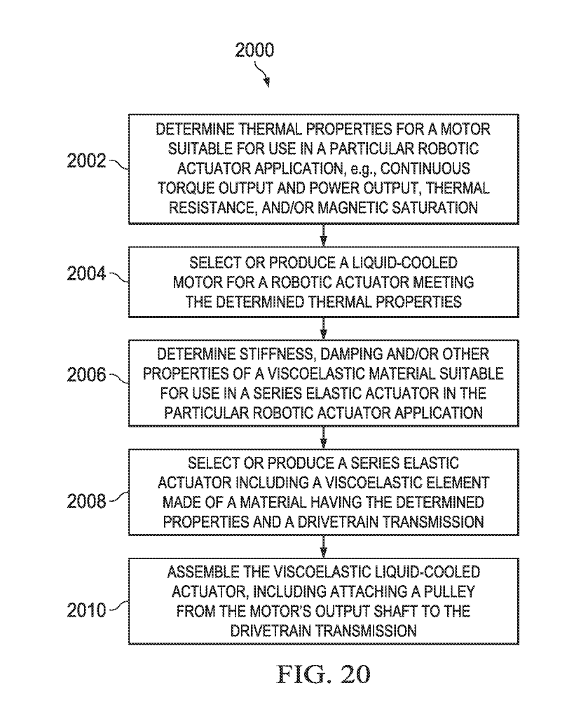

FIG. 20 illustrates selected elements of an example method 2000 for designing and building a viscoelastic liquid-cooled actuator (VLCA), according to at least one embodiment. The steps of method 2000 may begin at any suitable point, including 2002. Furthermore, the steps of method 2000 may be optionally repeated, looped, recursively executed, executed in various order, or omitted as necessary. Different steps of method 2000 may be executed in parallel with other steps of method 2000. In additional, further steps may be executed during execution of method 2000, wherein such further steps are not shown in FIG. 20 but are described herein or would be apparent to one of skill.

In this example embodiment, the method includes (at 2002), determining the thermal properties for a motor suitable for use in a particular robotic actuator application, such as continuous torque output and power output, thermal resistance, and/or magnetic saturation. The method also includes (at 20014) selecting or producing a liquid-cooled motor for a robotic actuator meeting the determined thermal properties, such as a motor housed in the maintainable liquid cooling jacket described herein.

In this example embodiment, the method includes (at 2006) determining stiffness, damping and/or other properties of a viscoelastic material suitable for use in a series elastic actuator in the particular robotic actuator application. The method also includes (at 2008) selecting or producing a series elastic actuator that includes a viscoelastic element made of a material having the determined properties and a drivetrain transmission. For example, the series elastic actuator may include this viscoelastic element in series with the motor and a drivetrain transmission, as described herein.

In this example embodiment, the method includes (at 2010) assembling the viscoelastic liquid-cooled actuator, which includes attaching a pulley from the motor's output shaft to the drivetrain transmission.

Note that while several of the examples described herein are directed primarily to the use of viscoelastic materials in prismatic actuators (which is a family of linear actuators in which the actuator elongates and then contracts), in other embodiments, these materials may be used in other types of robotic actuators, including any in the family of rotary actuators (which are cylindrical devices that spin around). For example, the components making up various SEAs (e.g., the motors, speed reduction elements, compliant elements, and transmission mechanisms) may be chosen and configured in many different ways, producing designs with various tradeoffs which affect the power output, volumetric size, weight, efficiency, back-drivability, impact resistance, passive energy storage, backlash, and torque ripple of a SEA, among other characteristics. Various rotary SEAs may be designed based on, for example, commercially available components including a planetary gearbox for the speed reduction, rotary or compression springs as the compliant element, and power transmission through a bevel gear or chain/cable; a harmonic drive and a high-stiffness planar spring; linear springs coupled to rotary shafts and placed between the motor and the chassis ground to achieve compact actuator packaging with low spring stiffness; springs placed within the reduction phase; a worm-gear/rotary-spring/spur-gear design which allows an orthogonal placement of the motor relative to the joint axis; prismatic designs which use ball screws as the primary reduction mechanism followed by a cable drive to remotely drive a revolute joint; a ball screw speed reduction that removes the need for a cable transmission by directly driving the joint output with a pushrod mechanism; and/or other design elements. In different embodiments, any or all of these designs may be improved through the use of viscoelastic elements rather than rigid metal springs or other elastic elements that do not provide damping. In addition, any or all of the actuators described herein (including those with metal springs and those that use viscoelastic elements) may, in various embodiments, include a liquid-cooled motor with a maintainable liquid cooling jacket and/or a liquid-cooled motor driver with a maintainable liquid cooling jacket, as described herein.

Compared to current motor cooling technologies, the maintainable liquid cooling jacket described herein may lead to lower maintenance costs for robotic systems developed using this technology. While several example embodiments are described in which the maintainable liquid cooling jacket is applied to a particular size and type of motor, in other embodiments this approach may be applied to improve the performance of different commercial or custom motors or motor drivers (e.g., servo drivers), including, but not limited to, those used in or with different types of robotic actuators. An analysis of an example viscoelastic liquid-cooled actuator (VLCA) design has demonstrated that a device incorporating both the maintainable liquid cooling jacket described herein and a series elastic actuator that includes a viscoelastic material in compression may achieve improved efficiency, power density, impact tolerance, position controllability, and force controllability when compared to existing robotic actuator designs.

Although only exemplary embodiments of the present disclosure are specifically described above, it will be appreciated that modifications and variations of these examples are possible without departing from the spirit and intended scope of the disclosure.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by the law, the scope of the present disclosure is to be determined by the broadest permissible interpretation of the following claims and their equivalents, and shall not be restricted or limited by the foregoing detailed description.

What is claimed is:

1. A liquid-cooled motor, comprising:
a front-most portion, comprising:
a cavity through which an output shaft of the liquid-cooled motor extends;
a fluid interface including an inlet and an outlet through which liquid is to flow;
a motor housing portion, comprising:
an electric motor;
a liquid cooling jacket in which the electric motor is enclosed, the liquid cooling jacket comprising a plurality of fluid channels that encircle the electric motor;
one or more removable fluid seals between the front-most portion and the motor housing portion.

2. The liquid-cooled motor of claim 1, wherein the one or more removable fluid seals comprise one or more rubber gaskets or O-rings.

3. The liquid-cooled motor of claim 1, wherein the front-most portion and the motor housing portion are connected to each other using one or more removable screws.

4. The liquid-cooled motor of claim 1, wherein the motor jacket is constructed from a watertight acrylic polymer.

5. The liquid-cooled motor of claim 1, wherein the motor jacket is constructed using a three-dimensional (3D) printing process.

6. The liquid-cooled motor of claim 1, wherein the front-most portion is machined from a polymer, a resin, a plastic, or an engineering thermoplastic.

7. The liquid-cooled motor of claim 1, wherein the electric motor is a commercial off-the-shelf electric motor.

8. The liquid-cooled motor of claim 1, wherein:
the liquid-cooled motor further comprises:
a rear-most portion;
one or more removable fluid seals between the rear-most portion and the motor housing portion;
the rear-most portion and the motor housing portion are connected to each other using one or more removable screws.

9. The liquid-cooled motor of claim 8, wherein the rear-most portion is machined from a polymer, a resin, a plastic, or an engineering thermoplastic.

10. A method for fabricating a liquid-cooled motor, comprising:
obtaining an electric motor;
producing a liquid-cooling jacket of suitable size and shape to enclose the electric motor, the liquid-cooling jacket including multiple fluid channels;
producing a front-most portion of the liquid-cooled motor, the front-most portion comprising:
a fluid interface comprising an inlet fitting for tubing and an outlet fitting for tubing;
a cavity through which an output shaft of the electric motor extends when the liquid-cooled motor is assembled;
assembling the liquid-cooled motor, the assembling including:
enclosing the electric motor in the liquid-cooling jacket;
placing one or more removable fluid seals between the liquid-cooling jacket and the front-most portion;
attaching the front-most portion to the liquid-cooling jacket using one or more removable screws.

11. The method of claim 10, wherein producing the liquid-cooling jacket comprises creating the liquid-cooling jacket using a three-dimensional (3D) printing process.

12. The method of claim 10, wherein producing the liquid-cooling jacket comprises creating the liquid-cooling jacket from a watertight acrylic polymer.

13. The method of claim 10, wherein obtaining an electric motor comprises obtaining a commercial off-the-shelf electric motor.

14. The method of claim 10, wherein the one or more removable fluid seals comprise one or more gaskets or O-rings.

15. The method of claim 10, wherein:
the method further comprises producing a rear-most portion;
assembling the liquid-cooled motor further comprises:
placing one or more removable fluid seals between the liquid-cooling jacket and the rear-most portion;
attaching the rear-most portion to the liquid-cooling jacket using one or more removable screws.

16. The method of claim 15, wherein:
producing a front-most portion of the liquid-cooled motor comprises machining the front-most portion from a polymer, a resin, a plastic, or an engineering thermoplastic; or
producing a rear-most portion of the liquid-cooled motor comprises machining the rear-most portion from a polymer, a resin, a plastic, or an engineering thermoplastic.

17. The method of claim 15, further comprising, subsequent to said assembling:
detaching the rear-most portion from the liquid-cooling jacket by removing at least one removable screw;
replacing at least one of the one or more removable fluid seals between the liquid-cooling jacket and the rear-most portion;
re-attaching the rear-most portion to the liquid-cooling jacket using at least one removable screw.

18. The method of claim 10, further comprising, subsequent to said assembling:
detaching the front-most portion from the liquid-cooling jacket by removing at least one removable screw;
replacing at least one of the one or more removable fluid seals between the liquid-cooling jacket and the front-most portion;
re-attaching the front-most portion to the liquid-cooling jacket using at least one removable screw.

19. A robotic actuator, comprising:
a liquid-cooled motor to generate mechanical power, the liquid-cooled motor to include a removable liquid-cooling jacket in which an electric motor is enclosed;
a speed reduction element to amplify motor torque;
an elastic element to sense force; and
a transmission mechanism to route mechanical power to an output joint.

20. The robotic actuator of claim 19, wherein:
the liquid-cooled motor comprises:
a front-most portion, comprising:
a cavity through which an output shaft of the liquid-cooled motor extends;
a fluid interface including an inlet and an outlet through which liquid is to flow;
a motor housing portion, comprising:
the electric motor;
the removable liquid cooling jacket, the removable liquid cooling jacket comprising a plurality of fluid channels that encircle the electric motor;
one or more removable fluid seals between the front-most portion and the motor housing portion;
the front-most portion and the motor housing portion are connected to each other using one or more removable screws.
